(19) United States
(12) Patent Application Publication
(10) Pub. No.: US 2025/0392985 A1
(43) Pub. Date: Dec. 25, 2025

(54) ENERGY EFFICIENT FOR MASSIVE AND EXTREME MASSIVE MULTIPLE-INPUT MULTIPLE-OUTPUT (MMIMO) SYSTEMS

(71) Applicant: DISH Wireless L.L.C., Englewood, CO (US)

(72) Inventors: Joohyun Lee, Suwon-si (KR); Daejoong Kim, Seoul (KR); Minho Song, Ashburn, VA (US); Sang Boh Yun, Ashburn, VA (US); Sourabh Gupta, Ashburn, VA (US)

(21) Appl. No.: 18/908,379

(22) Filed: Oct. 7, 2024

Related U.S. Application Data
(60) Provisional application No. 63/662,629, filed on Jun. 21, 2024.

(51) Int. Cl. H04W 52/02; H04B 7/0413; H04B 7/06; H04B 17/318; H04B 17/336

(52) U.S. Cl. CPC H04W 52/02; H04B 7/0413; H04B 7/0626; H04B 17/318; H04B 17/336

(57) ABSTRACT

Technologies for providing energy efficiency technology in extreme mMIMO systems in a cellular network cellular network (e.g., 5G wireless network, 6G wireless network) are described. The method collects data representing conditions for potential energy saving (ES) modes, comprising morphology data and traffic pattern data. The method determines, using the collected data, one or more energy saving (ES) modes for one or more components of a cellular network in at least one of a time (T) domain, a frequency (F) domain, or a space (S) domain, wherein the one or more ES modes cause at least one adjustment to the one or more components in the at least one of the time (T) domain, the frequency (F) domain, or the space (S) domain.

### RELATED APPLICATIONS

This application claims the benefit of U.S. Patent Application No. 63/662,629, filed Jun. 21, 2024, the entire contents of which are incorporated herein by reference.

### BACKGROUND

This disclosure relates to wireless data networks. Wireless data networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers, and other devices. 5G technologies are capable of supplying much greater bandwidths than previously-available technologies. In addition, it is expected that higher data rate will be required in 6G and next generation.

Radio Units (RUs) in these wireless data networks can use Massively Multiple-Input Multiple-Output technology, also referred to as Massive MIMO or mMIMO technology. The mMIMO technology represents an advanced form of MIMO technology that significantly scales up the number of transceivers and antenna elements at a base station. By employing dozens or even thousands of antenna elements, mMIMO systems can simultaneously serve multiple data layers and multiple users within the same frequency band and same time slot, greatly enhancing the network's capacity, spectral efficiency, and throughput. This technology leverages sophisticated signal processing algorithms to manage the high volume of data streams, allowing for more efficient communication over current wireless networks. By better focusing the energy with precise beamforming, mMIMO reduces interference and increases the range and reliability of wireless communication, making it a cornerstone technology for next generation (NG) networks (e.g., 5G or 6G networks) and beyond.

### BRIEF DESCRIPTION OF THE DRAWINGS

The present disclosure is illustrated by way of example, and not by way of limitation, in the figures of the accompanying drawings. To easily identify the discussion of any particular element or act, the most significant digit or digits in a reference number refer to the figure number in which that element is first introduced.

FIG. 1A is a block diagram of a system implementing energy saving logic in a cellular network according to at least one embodiment.

FIG. 1B illustrates an aspect of the subject matter in accordance with one embodiment.

FIG. 2 shows an example Open Radio Access Network (O-RAN) architecture with energy saving logic according to at least one embodiment.

FIG. 3 illustrates an example of a mMIMO system and an extreme mMIMO system according to at least one embodiment.

FIG. 4 is a block diagram of an example extreme mMIMO system according to at least one embodiment.

FIG. 5 is a flow diagram of a method 500 for enabling one or more energy saving modes at a target RU according to at least one embodiment.

FIG. 6 illustrates an example physical resource block (PRB) transmitted from a node to a first UE according to at least one embodiment.

FIG. 7A illustrates an extreme mMIMO system with 256 antenna ports and corresponding amplifiers and transceivers according to at least one embodiment.

FIG. 7B illustrates a first combination of parameters of the extreme mMIMO system of FIG. 7A according to at least one embodiment.

FIG. 7C illustrates a third combination of parameters of the extreme mMIMO system of FIG. 7A according to at least one embodiment.

FIG. 7D illustrates a fourth combination of parameters of the extreme mMIMO system of FIG. 7A according to at least one embodiment.

FIG. 7E illustrates a fifth combination of parameters of the extreme mMIMO system of FIG. 7A according to at least one embodiment.

FIG. 7F illustrates a sixth combination of parameters of the extreme mMIMO system of FIG. 7A according to at least one embodiment.

FIG. 7G illustrates a seventh combination of parameters of the extreme mMIMO system of FIG. 7A according to at least one embodiment.

FIG. 7H illustrates a second combination of parameters of the extreme mMIMO system of FIG. 7A according to at least one embodiment.

FIG. 8 illustrates an example ES mode schedule of different durations of the combinations according to at least one embodiment.

FIG. 9 is an ES Saving table with different time durations and the corresponding conditions according to at least one embodiment.

FIG. 10 shows an illustrative architecture of an example non-real-time radio access network intelligent controller (RICs) with energy saving logic according to at least one embodiment.

FIG. 11 shows an example of a virtual RIC platform on a near-real time RIC with energy saving logic according to at least one embodiment.

FIG. 12 shows a system diagram that illustrates an example computing system that implements and/or comprises one or more components of a system that implements multi-tenant network applications on a RIC platform.

FIG. 13 is a flow diagram of a method for energy saving operations according to at least one embodiment.

FIG. 14 is a flow diagram of a method of training energy saving (ES) models and using trained ES models for interference according to at least one embodiment.

FIG. 15 is a block diagram of an example architecture of a customizable pipeline that supports training, configuring, and deploying of one or more machine learning models according to various aspects of the present disclosure.

FIG. 16A-FIG. 16D depicts various embodiment of a radio access network.

### DETAILED DESCRIPTION

Technologies for providing energy efficiency technology in extreme mMIMO systems in a cellular network cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

As described above, cellular networks can use mMIMO systems. However, the candidate spectrum for the 6G technology includes an upper mid-band between 7 and 24 GHz. Due to the higher frequency of this range, as compared to 5G, the 6G coverage will be significantly reduced. Therefore, coverage enhancement technologies are needed. The 6G technology's throughput requirement is more than ten times than 5G technology's throughput. To achieve the higher throughput, Extreme massive MIMO (extreme mMIMO) systems can be used. Extreme mMIMO represents an evolution of Massive MIMO technology, pushing the boundaries of antenna array sizes, number of transceivers, and system capabilities far beyond conventional Massive MIMO configurations. This advanced approach involves deploying thousands of antennas (or antenna elements) and transceivers at the base station, greatly exceeding the typical scales seen in Massive MIMO systems. By utilizing such a vast number of (or antenna elements) and antennas, extreme mMIMO aims to achieve unprecedented improvements in spectral efficiency, network capacity, and user throughput, while significantly reducing interference and enhancing signal quality. Extreme mMIMO technology can dynamically direct communication beams with extreme precision, targeting individual user equipment with unparalleled accuracy, thus minimizing interference across the network. This technology is foundational for future wireless communication systems, aiming to meet the burgeoning demand for higher data rates and more connections in scenarios such as dense urban environments, massive IoT deployments, and ultra-reliable low-latency communications. With its potential to transform wireless infrastructure, extreme mMIMO is poised to play a pivotal role in enabling the next generation of mobile networks, supporting the exponential growth of connected devices and applications requiring high bandwidth and low latency.

The higher frequency band in 6G can have a higher pathloss than in 5G, higher power amplifiers would be required. In addition, the number of transceivers would increase. For example, mMIMO systems can have 192 antenna elements with 64 transceiver and power amplifiers with a total power of 320 watts (W), whereas extreme mMIMO systems can have 1024 antenna elements with 256 transceivers and power amplifiers with a total power greater than 640 W. Given the increased total power from the increased number of transceivers, power amplifiers, and antenna elements in the extreme mMIMO systems, extreme mMIMO systems would benefit from energy saving technologies, such as those described herein.

Aspects and embodiments of the present disclosure address the above and other deficiencies by providing energy efficiency technologies for mMIMO and extreme mMIMO systems in a cellular network (e.g., 5G wireless network, 6G wireless network). Aspects and embodiments of the present disclosure can provide improved power consumption in these systems while still meeting performance requirements. Aspects and embodiments of the present disclosure can provide energy savings in three energy saving domains, including a time (T) domain, a frequency (F) domain, and a space (S) domain, as described in more detail below.

In particular, for the time (T) domain, there can be energy savings achieved at a symbol level or a scheduler level. Most of the latest communication standards such as Wi-Fi, 4G LTE, and 5G NR support multi-subcarrier modulation based on orthogonal frequency division multiplexing (OFDM). A modulation symbol is assigned to each subcarrier in the frequency domain and converted to the time domain using Inverse Fast Fourier Transform (IFFT). The sample set of IFFT size generated in this way is the OFDM symbol. An OFDM symbol ranges from tens of microseconds (10s μs) to hundreds of microseconds (100 μs). A slot is a basic unit of scheduling where a few to dozens of OFDM symbols are gathered together. A scheduler is a sophisticated network function responsible for managing the allocation of radio resources (such as frequency bands, time slots, and modulation schemes) among multiple users and devices connected to the network. The scheduler operates within the base station (e.g., gNB) and can optimize network performance, capacity, and user experience by dynamically assigning these resources based on various criteria, including user demand, service quality requirements, device capabilities, and network conditions. The scheduler level refers to a scheduling slot duration, within hundreds of us to 1 milliseconds (ms). The statistical level refers to the duration of change in communication traffic, such as day and night, and is usually in units of several hours.

For the frequency (F) domain, there can be energy savings achieved at a carrier level, a Bandwidth Part (BWP) or a sub-bandwidth of a full bandwidth of a carrier, or a Resource Block (RB) or group of RBs level. A carrier refers to a specific frequency band within the electromagnetic spectrum that is used to transmit and receive data signals between UE and the network's base stations. These carriers are the fundamental building blocks for establishing wireless connections and facilitating the exchange of information across the wireless data network. BWP is a term used in the context of New Radio (NR) technology, referring to a feature designed to improve spectrum efficiency, flexibility, and power consumption for mobile networks and devices. A BWP is essentially a subset of the total available bandwidth that a network can dynamically assign to a device based on its current needs and conditions. BWPs allow for more efficient spectrum use, as different BWPs can be activated or deactivated depending on the data requirements of the device, the type of application being used, or the current network load. This flexibility enables a more targeted and efficient allocation of radio resources, helping to optimize network performance and reduce power consumption on the device side by limiting its operation to the necessary bandwidth only. The sub-bandwidth of the full bandwidth of a carrier can be used in 4G, 6G, etc. A resource block (RB) represents the smallest unit of radio resources that can be allocated by the network to a UE. An RB includes a specific number of subcarriers in the frequency domain and a certain number of symbols in the time domain.

For the space (S) domain, there can be energy savings achieved at a power amplifier level, a transceiver (TRx) chain level (e.g., radio frequency integrated circuit (RFIC), digital front end (DFE)), or a beam level (e.g., beamforming/beam management). In the context of wireless communications, an antenna path refers to the specific signal pathway through which electromagnetic waves travel between the transmitter and receiver, facilitated by the antenna system. Antenna elements refer to the individual components within an antenna array responsible for transmitting and receiving electromagnetic waves. Each antenna element can be considered a single antenna in its own right, capable of emitting or capturing radio frequency (RF) signals. When multiple elements are arranged in an array, they can be controlled independently or in coordination to manipulate the radiation pattern of the antenna system. This is achieved by adjusting the amplitude and phase of the signal at each element, allowing the array to focus energy in specific directions to create beams. Beamforming is a signal processing technique employed by antenna arrays containing multiple antenna elements. By controlling the phase and amplitude of the signal at each antenna element, the antenna array can direct the main lobe of the radiation pattern towards a specific user or device, creating a focused beam of energy. This directed beam can significantly enhance the signal-to-interference-plus-noise ratio (SINR) at the receiver, improving the overall quality and reliability of the wireless connection. Beam management refers to the set of procedures and protocols designed to ensure the optimal configuration and adaptation of beamforming over time and in dynamic conditions. In a typical massive MIMO, there is one transceiver, one power amplifier, and one antenna element or multiple antenna elements. For example, there can be 64 TxRx transceivers×3 AE=192 AE (antenna elements).

Aspects and embodiments of the present disclosure can collect data (input) representing conditions for potential energy saving (ES) modes, including morphology (e.g., environment) and traffic patterns (time, season, etc.), and determine, using the collected data, energy saving (ES) modes (output) in time (T), frequency (F), and space (S) domains. The ES modes can include instantaneous on/off in the time (T), frequency (F), and space (S) domains, sleep modes, hibernation modes, or other lower-power modes.

In at least one embodiment, the energy efficiency technology can be implemented as energy saving logic in a controller. The energy saving logic can use thresholds, algorithms, ranges, or the like to determine energy saving modes based on the collected data. In at least one embodiment, the energy savings logic can use artificial intelligence (AI) or machine learning (ML) models for mMIMO and extreme mMIMO systems in a cellular network. For example, an AI/ML energy saving (ES) model can be trained with input and output data, where the input data can be the UE traffic data, UE signal to noise, UE RSSI, UE channel state information (CSI), the number of UEs, RB usage rate, and morphology information, and the output data can be network key performance indicator(s) (KPI(s)) (also referred to as monitored data). The input data can represent conditions for potential ES modes in a cellular network. The input data can include morphology data and traffic pattern data. The traffic data can vary based on the morphology. Energy consumption can be one of the KPIs. The AI/ML ES model can be trained for ES domains (T, F, and S) and ES modes. The AI/ML ES model can be deployed for ES model inference. Inference data, including UE traffic pattern and morphology data, can be collected and input into the trained AI/ML ES model for ES model inference. The ES model inference can cause one or more actions to be performed to achieve energy savings in one or more of the ES domains (T, F, and S). In addition, the ES model inference can output network KPIs for ES model performance modeling, which can feedback into the ES model training, in response to one or more triggers. For example, the KPIs can include sector average throughput, peak throughput, total number of UE, Voice over New Radio (VoNR) Mean Opinion Score (MOS), latency, Handover failure rate, etc. The ES model performance can be power consumption, ES statistics, etc. In other embodiments, other predictive equations or models can be used to determine energy savings modes based on the collected data.

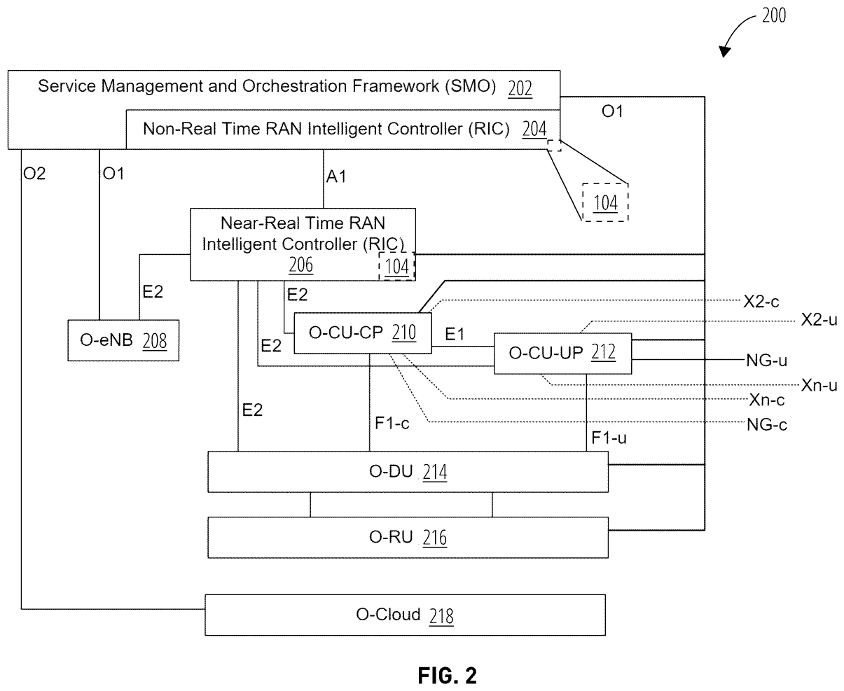

In at least one embodiment, the energy efficiency technology can be implemented as energy saving logic in a controller that can control components of a radio access network (RAN). For example, in an Open Radio Access Network (O-RAN) architecture, the energy saving logic can be implemented in a Radio Access Network Intelligent Controller (RIC), such as described in more detail below with respect to FIG. 2. In another embodiment, the controller can be implemented in an Element Management System (EMS) or in a separate system. The controller can be implemented in a cloud computing environment or conventional dedicated system. In other embodiments, the energy saving logic can be deployed in a controller in other components of a cellular network.

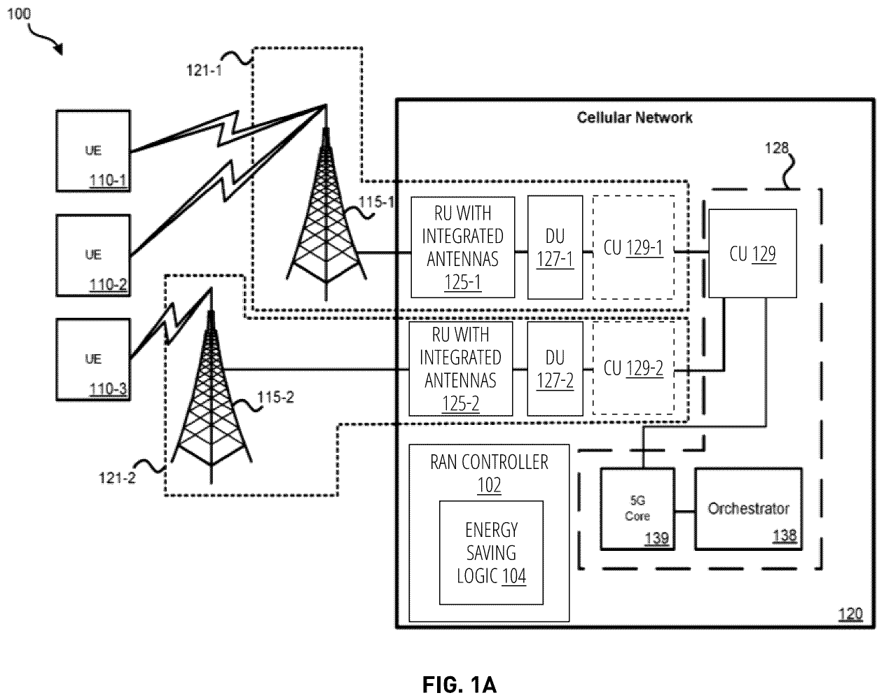

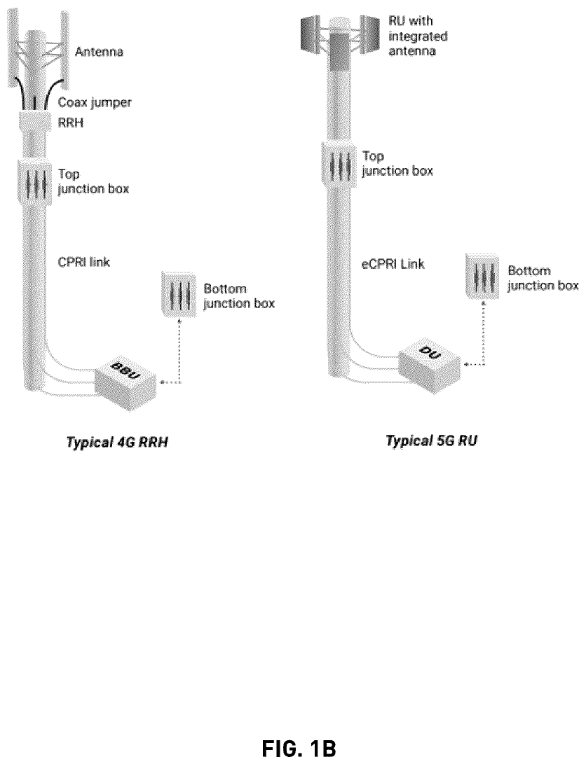

FIG. 1A is a block diagram of a cellular network system 100 (“system 100”) implementing energy saving logic 104 in a cellular network according to at least one embodiment. FIG. 1A represents an embodiment of a cellular network which can accommodate the cloud-based architecture. System 100 can include a 5G New Radio (NR) cellular network; other types of cellular networks, such as 6G, 7G, etc. System 200 can include: UEs 110 (UE 110-1, UE 110-2, UE 110-3); base stations 121; cellular network 120; RU with integrated antennas 125 (“RUs 125”); distributed units 127 (“DUs 127”); CU 129 (“CU 129”); network core 139 (e.g., 5G core, 6G core), and orchestrator 138. FIG. 1A represents a component-level view. FIG. 1B illustrates a tower with a typical 4G Remote Radio Head (RRH) and a tower with a typical 5G RU. As illustrated in the tower for a typical 5G RU, the RU can be attached to the tower like the RRH in the 4G RRH, but for massive MIMO, the RU and antennas are integrated at the tower. In an Open Radio Access Network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), CPE (Custom Premises Equipment), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations are illustrated: base station 121-1 can include: structure 115-1, RU with integrated antennas 125-1, and DU 127-1. The RU with integrated antennas 125 couple to the DU through an enhanced Common Public Radio Interface (eCPRI) fronthaul. Each of the DUs 127-1 and 127-2 can be coupled to a CU 129. In another embodiment, the base station 121-1 can include: structure 115-1, RU with integrated antennas 125-1, DU 127-1, and CU 129-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU with integrated antennas 125-2, and DU 127-2. As described above, each of the DUs 127-1 and 127-2 can be coupled to a CU 129. In another embodiment, the base station 121-2 can include: structure 115-2, RU with integrated antennas 125-2, DU 127-2, and CU 129-2.

Real-world implementations of system 100 can include many (e.g., thousands) of base stations and many CUs and network core 139. BS 121 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), 6G NR, or some other RAT. The remainder of cellular network 120 may be based on an exclusive 6G architecture, an exclusive 5G architecture, a hybrid 4G/5G architecture, a 4G architecture, or some other cellular network architecture. Base station equipment may include an RU (e.g., RU with integrated antennas 125-1), a DU (e.g., DU 127-1), and a CU (e.g., 129-1).

One or more RUs, such as RU with integrated antennas 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 77 (n77). A typical massive MIMO band is TDD, including n48 (CBRS) and n77 (C-band). One or more DUs, such as DU 127-1, may communicate with CU 129. Collectively, an RU, DU, and CU create a gNodeB, which serves as the radio access network (RAN) of cellular network 120. CU 129 can communicate with network core 139. The specific architecture of cellular network 120 can vary by embodiment. The cellular network 120 can include antennas and UEs. Edge cloud server systems outside of cellular network 120 may communicate, either directly, via the Internet, or via some other network, with components of cellular network 120. For example, DU 127-1 may be able to communicate with an edge cloud server system without routing data through CU 129 or network core 139. Other DUs may or may not have this capability.

While FIG. 1A illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and network core 139. Functionality of such components can be co-located or located at disparate physical server systems. For example, certain components of network core 139 may be co-located with components of CU 129.

In a possible virtualized O-RAN implementation, CU 129, network core 139, and/or orchestrator 138 can be implemented virtually as software being executed by general-purpose computing equipment, such as in a data center of a cloud-computing platform, as detailed herein. Therefore, depending on needs, the functionality of a CU 129, and/or network core 139 may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, network core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QOS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU with integrated antennas 125-1 and DU 127-1, a second set of network slices, which may only partially overlap or may be wholly different from the first set, may be reserved at RU with integrated antennas 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and network core 139 may include various software components that are required to communicate with each other, handle large volumes of data traffic, and are able to properly respond to changes in the network.

The network core 139 (e.g., 5G core or 6G core), which can be physically distributed across data centers or located at a central national data center (NDC), can perform various core functions of the cellular network. The network core 139 can include: network resource management components; policy management components; subscriber management components; and packet control components. Individual components may communicate on a bus, thus allowing various components of network core 139 to communicate with each other directly. The network core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection- and session-related information from UE and is responsible for handling connection and mobility management tasks. SMF is responsible for interacting with the decoupled data plane, creating, updating, and removing protocol data unit (PDU) sessions, and managing session context with the user plane function (UPF).

User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

The network core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

In some embodiments, the cellular network 120 includes a RAN controller 102 that implements energy saving logic 104 for performing energy savings in the time (T), frequency (F), and space (S) domains in the cellular network. In some embodiments, the RAN controller 102 is part of the cloud-based cellular network components 128. In other embodiments, the RAN controller 102 is part of the orchestrator 138. In other embodiments, the energy saving logic 104 can be implemented in separate components, such as the RUs 125, the DUs 127, the CU 129, the network core 139, and the orchestrator 138.

In at least one embodiment, the energy saving logic 104 of RAN controller 102 can monitor and collect data, including morphology data, traffic pattern data in terms of T, F, and S domains. The energy saving logic 104 can determine or otherwise identify energy saving modes in the T, F, and S domains, including long-term energy saving modes and RAN policies and mid-term and short-term energy saving modes and DU/RU configurations, and short-term energy saving modes. Once the energy saving modes and configurations are determined or otherwise identified, the energy saving logic 104 can send the energy saving mode setup and configuration data to one or more target RUs (RU with integrated antenna (e.g., massive MIMO system)) to enable efficiency energy saving modes on the one or more RUs, while minimizing cell coverage degradation by exchanging coverage compensation information with neighboring RUs/BSs.

The term “morphology” refers to the study and consideration of the physical layout, structure, and characteristics of the environment in which the cellular network is deployed. For example, some urban environments are characterized by high-rise buildings and dense infrastructure and present challenges for signal propagation due to the high probability of blockage and reflection. High-frequency signals, such as those used in the mmWave spectrum, are particularly susceptible to attenuation from buildings. Since massive MIMO provides vertical beamforming and horizontal beamforming, mMIMO is a good solution in the urban environments with many high-rise buildings. Using the vertical beam, mMIMO can provide better three-dimensional coverage. Suburban environments typically feature lower building densities and more open spaces than urban areas. The challenges here often involve providing consistent coverage over larger areas with fewer obstacles but potentially greater distances between network infrastructure and end-users. Rural morphologies, with their wide-open spaces and fewer physical obstructions, present a different set of challenges, primarily related to achieving wide-area coverage and maintaining signal strength over long distances with minimal infrastructure. Understanding the morphology of the deployment area is crucial for network planning, including the placement of cell towers, base stations, and antenna arrays to optimize coverage, capacity, and performance. Effective planning needs to account for the morphological features of the environment to ensure that the network can deliver the expected level of service. Understanding the morphology, massive MIMO beam pattern can be optimized in vertical or horizontal or both.

Advanced antenna technologies such as beamforming can be adapted to the specific morphological characteristics of the deployment environment. Beamforming techniques can be optimized to navigate around or mitigate the impact of physical obstructions, enhancing signal reach and reliability. Indoor morphology, including building materials and layouts, significantly impacts signal propagation, particularly for higher frequency bands. Strategies to enhance coverage of high-rise buildings might include the use of in-building distributed antenna systems (DAS) or massive MIMO. The morphology of outdoor environments influences the design and optimization of outdoor networks, including the selection of antenna types and their placement to ensure robust outdoor coverage. The morphology data can be used by the energy saving logic 104 to identify energy saving modes in the T, F, and S domains.

Traffic patterns refer to the characteristics and behaviors of data flow across the network. The traffic patterns can include various parameters, such as traffic load, number of UEs, types of traffic (voice, data, etc.), etc. The traffic patterns can vary depending on the morphology. These patterns are used for network planning, design, and optimization as they impact how resources are allocated and managed to meet user demands and service quality requirements. 5G brings more complexity to traffic patterns due to its support for a wide array of services, including enhanced Mobile Broadband (eMBB), Ultra-Reliable and Low Latency Communications (URLLC), and Massive Machine Type Communications (mMTC). eMBB traffic patterns are characterized by high data rate transmission for services like video streaming, virtual reality (VR), and augmented reality (AR). These applications require substantial bandwidth and generate large amounts of data, leading to peak traffic volumes that can significantly strain network resources. Traffic patterns for URLLC are characterized by the need for immediate response times and high reliability, even if the data packets are relatively small compared to eMBB. mMTC traffic involves a large number of IoT devices transmitting small data packets intermittently or at regular intervals. This leads to a high density of connections but generally lower individual data rates. However, the sheer volume of devices can create congestion and requires efficient signaling and resource allocation. To efficiently handle diverse traffic patterns, 5G networks utilize advanced technologies like network slicing, which allows the network to allocate resources dynamically based on the specific needs of different services. This way, eMBB services can receive the bandwidth they need, while URLLC services are guaranteed the latency and reliability they require. Effective traffic management strategies can prevent congestion, especially in areas or times of high demand. This includes deploying techniques such as load balancing, traffic shaping, and priority-based queuing to ensure that services (e.g., URLLC) are not negatively affected by congestion. Leveraging predictive analysis and machine learning can help in anticipating traffic demands and patterns, enabling the network to pre-emptively adjust resources and manage traffic flow to maintain service quality. Deploying edge computing resources can help in managing traffic patterns by processing data closer to the user, which is beneficial for applications requiring low latency or involving localized data processing. The traffic pattern data can be used by the energy saving logic 104 to identify energy saving modes in the T, F, and S domains.

In at least one embodiment, the energy saving logic 104 can identify energy saving modes in the time (T) domain, including energy saving modes at an OFDM symbol level. As described above, an OFDM symbol represents the smallest set of samples in a radio interface that uses OFDM modulation scheme. OFDM symbols are organized into RBs, slots, subframes, and frames as part of the overall radio frame structure, facilitating the scheduling and timing of data transmissions between network base stations (e.g., gNBs) and user equipment (UE). In at least one embodiment, the energy saving logic 104 can identify energy saving modes that adjust a symbol level used by an RU.

In at least one embodiment, the energy saving logic 104 can identify energy saving modes in the time (T) domain, including energy saving modes at a scheduler level. As described above, a scheduler is a sophisticated network function responsible for managing the allocation of radio resources (such as frequency bands, time slots, spatial streams, and modulation schemes) among multiple users and devices connected to the network. The scheduler operates within the base station (gNB) and can optimize network performance, capacity, and user experience by dynamically assigning these resources based on various criteria, including user demand, service quality requirements, device capabilities, and network conditions. This structured approach allows cellular networks to efficiently manage the transmission of data across a wide range of frequencies and to support the diverse requirements of different applications and services, from high-speed mobile broadband to reliable, low-latency communication for industrial IoT and autonomous vehicles. In at least one embodiment, the energy saving logic 104 can identify energy saving modes that adjust schedules used by the scheduler.

In at least one embodiment, the energy saving logic 104 can identify energy saving modes in the frequency (F) domain, including energy saving modes at a carrier level. As described above, a carrier refers to a specific frequency band within the electromagnetic spectrum that is used to transmit and receive data signals between UE and the network's base stations. These carriers are the fundamental building blocks for establishing wireless connections and facilitating the exchange of information across the wireless data network. 5G and 6G technology utilizes a wide range of frequency bands, which are broadly categorized into two segments: Sub-6 GHz bands for coverage and penetration into buildings, and Millimeter Wave (mmWave) bands, which offer higher bandwidths and support data rates of multiple gigabits per second (Gbps), albeit over shorter distances and with less penetration through obstacles. Each carrier occupies a specific bandwidth within its frequency band, and multiple carriers can be aggregated to increase the total available bandwidth for a user or service, a technique known as Carrier Aggregation (CA). This approach enhances the network's capacity, speed, and efficiency, enabling the cellular network to support a vast number of devices and demanding applications, from high-definition video streaming and virtual reality to autonomous driving and smart cities. Furthermore, 5G and 6G incorporate flexible deployment models, allowing carriers to be dynamically configured and optimized in real-time based on user demand, service requirements, and network conditions. This flexibility is pivotal for accommodating the diverse and evolving needs of 5G use cases, ensuring optimal resource utilization and network performance. In at least one embodiment, the energy saving logic 104 can identify energy saving modes that adjust the carrier levels being used.

In at least one embodiment, the energy saving logic 104 can identify energy saving modes in the frequency (F) domain, including energy saving modes at a BWP level. BWP is a term used in the context of New Radio (NR) technology, referring to a feature designed to improve spectrum efficiency, flexibility, and power consumption for mobile networks and devices. A BWP is essentially a subset of the total available bandwidth that a network can dynamically assign to a device based on its current needs and conditions. The introduction of BWPs allows for more efficient spectrum use, as different BWPs can be activated or deactivated depending on the data requirements of the device, the type of application being used, or the current network load. This flexibility enables a more targeted and efficient allocation of radio resources, helping to optimize network performance and reduce power consumption on the device side by limiting its operation to the necessary bandwidth only. Bandwidth Parts are used for supporting a wide range of use cases and ensuring optimal performance across diverse scenarios, from low-power, low-data Internet of Things (IoT) applications to high-throughput, low-latency services like virtual reality (VR) and ultra-high-definition video streaming. In at least one embodiment, the energy saving logic 104 can identify energy saving modes that adjust the BWPs being used.

In at least one embodiment, the energy saving logic 104 can identify energy saving modes in the frequency (F) domain, including energy saving modes at an RB level. A resource block (RB) represents the smallest unit of radio resources that can be allocated by the network to a UE. An RB includes a specific number of subcarriers in the frequency domain and a certain number of symbols in the time domain. In some embodiments, an RB is defined as 12 consecutive subcarriers in the frequency domain, with a bandwidth of approximately 180 kHz, spanning a time duration of one slot, which is 0.5 milliseconds in length, resulting in a total of 7 or 14 symbols per slot, depending on the cyclic prefix length. In 5G NR, the concept of a Resource Block is further refined to accommodate a wider range of frequencies and more flexible bandwidth allocations. The number of subcarriers in a Resource Block in 5G NR remains 12, similar to LTE, but the subcarrier spacing can vary (e.g., 15, 30, 60, 120, 240 kHz, etc.), affecting the time duration of symbols and thus allowing the network to adapt more dynamically to different use cases, from enhanced Mobile Broadband (eMBB) to Ultra-Reliable Low-Latency Communications (URLLC). In 5G networks, a resource block is defined as the smallest unit of resource allocation, including a certain number of subcarriers in the frequency domain combined with a specific number of OFDM (Orthogonal Frequency-Division Multiplexing) symbols in the time domain. For 6G, it is anticipated that the concept of a resource block evolve to incorporate even broader flexibility and efficiency, potentially adapting to a wider range of frequencies, including terahertz (THz) bands, and incorporating AI-driven dynamic allocation to further optimize network performance and energy usage. The dimensions of a 6G resource block could become more dynamic, with the introduction of new waveforms, modulation schemes, and access technologies that are more suited to the diverse and demanding requirements of future applications, including extremely high data rates, ultra-reliable low-latency communications (URLLC), massive machine-type communications (mMTC), and three-dimensional coverage extending to airborne and spaceborne platforms. Furthermore, with the integration of technologies such as Non-Orthogonal Multiple Access (NOMA), advanced beamforming, and intelligent surfaces, 6G networks can redefine resource allocation and management altogether, moving beyond the conventional time-frequency resource block structure to a more holistic and flexible approach that considers spatial and contextual dimensions, vastly increasing network capacity, and efficiency. Resource Blocks are key components in the scheduling and management of radio resources, enabling networks to efficiently distribute bandwidth and support multiple users and services simultaneously. By dynamically allocating Resource Blocks to different users based on their needs and network conditions, a more efficient and flexible utilization of the available spectrum is achieved, enhancing overall network performance, capacity, and user experience. In at least one embodiment, the energy saving logic 104 can identify energy saving modes that adjust the RBs being used.

In at least one embodiment, the energy saving logic 104 can identify energy saving modes in the space (S) domain, including energy saving modes at an antenna path level. As described above, an antenna path refers to the specific signal pathway through which electromagnetic waves travel between the transmitter and receiver, facilitated by the antenna system. This concept is particularly important in 5G and 6G networks due to their reliance on advanced antenna technologies, such as mMIMO, extreme mMIMO, beamforming, to improve signal coverage, capacity, and the efficiency of spectrum usage. An antenna path encompasses the series of components and media the signal traverses from the radio unit of a base station (or gNodeB in 5G terminology) through its antenna arrays, across the air interface, and finally to the receiving device's antenna system, or vice versa. Each antenna path involves the generation, amplification, and radiation of radio frequency (RF) signals in the transmit direction, and the reception, filtering, and demodulation of those signals in the receive direction. 5G systems often utilize multiple antenna paths to support MIMO operations, enabling the simultaneous transmission and reception of multiple data streams between a base station and UE. By exploiting differences in the path characteristics, such as path loss, delay, and fading, MIMO technology can significantly increase the data throughput and reliability of wireless communications. Furthermore, with the implementation of beamforming techniques, 5G networks dynamically adjust the phase and amplitude of the signals at each antenna element to create focused beams directed towards specific users or areas. This steerable beam approach enhances the efficiency of antenna paths by improving signal strength and reducing interference, enabling higher data rates and more consistent connectivity for users moving across the network. Overall, the optimization and management of antenna paths are crucial for maximizing the performance and efficiency of 5G networks, accommodating the dramatic increase in data traffic, and supporting the diverse requirements of next-generation wireless services. In at least one embodiment, the energy saving logic 104 can identify energy saving modes that adjust the antenna paths being used.

In at least one embodiment, the energy saving logic 104 can identify energy saving modes in the space (S) domain, including energy saving modes at an antenna element level. As described above, antenna elements refer to the individual components within an antenna array responsible for transmitting and receiving electromagnetic waves. These elements work together to form the operational backbone of advanced technologies like beamforming and Massive MIMO (Multiple Input Multiple Output), which are pivotal for achieving the high data rates, increased capacity, and improved efficiency that 5G networks offer. Each antenna element can be considered a single antenna in its own right, capable of emitting or capturing radio frequency (RF) signals. When multiple elements are arranged in an array, they can be controlled independently or in coordination to manipulate the radiation pattern of the antenna system. This is achieved by adjusting the amplitude and phase of the signal at each element, allowing the array to focus energy in specific directions to create beams. This beamforming capability enables the network to dynamically target and follow users as they move, enhancing signal quality, reducing interference, and increasing overall network performance. The use of multiple antenna elements in arrays supports the implementation of MIMO techniques, where multiple signals are transmitted and received over the same frequency channel by utilizing spatial diversity. In 5G networks, Massive MIMO takes this concept further by leveraging a very large number of antenna elements (potentially hundreds or even thousands) to serve many users simultaneously within the same cell, significantly boosting both spectral efficiency and capacity. It should be noted that mMIMO provides many more layers or data streams to a UE (Single-User MIMO (SU-MIMO)) than non-mMIMO systems. mMIMO also supports much more data to many different UEs (Multi-User MIMO (MU-MIMO)) using the same frequency and same time resource. Antenna elements in 5G networks are designed to operate over a wide range of frequencies, including the Sub-6 GHz bands for widespread coverage and capacity, as well as Millimeter Wave (mmWave) bands for ultra-high data speeds in dense urban or indoor environments. The physical design and arrangement of these elements are key factors in determining the performance characteristics of the 5G antenna system, influencing aspects such as directionality, gain, and the ability to mitigate path loss and fading, which are more pronounced at higher frequencies. Overall, antenna elements are integral to the functionality and advancements in 5G wireless technology, enabling more efficient use of the spectrum and providing the foundation for innovative applications and use cases in the era of next-generation networks. In at least one embodiment, the energy saving logic 104 can identify energy saving modes that adjust the antenna elements being used.

In at least one embodiment, the energy saving logic 104 can identify energy saving modes in the space (S) domain, including energy saving modes at a beam level (e.g., beamforming/beam management). As described above, beamforming and beam management are crucial techniques used to improve signal quality, enhance network capacity, and ensure efficient use of the frequency spectrum, especially in the higher frequency bands like mmWave, where signal attenuation and interference are more significant. Beamforming is a signal processing technique employed by antenna arrays containing multiple antenna elements. By controlling the phase and amplitude of the signal at each antenna element, the antenna array can direct the main lobe of the radiation pattern towards a specific user or device, creating a focused beam of energy. This directed beam can significantly enhance the signal-to-interference-plus-noise ratio (SINR) at the receiver, improving the overall quality and reliability of the wireless connection. In 5G networks, beamforming is used not only to boost signal strength but also to support high data rate transmissions over the upper Sub-6 GHz frequencies as well as higher frequencies (e.g., 7-24 GHZ), which are highly directional and susceptible to blockage and attenuation. Beamforming helps to mitigate these challenges by effectively focusing the radio energy, maximizing the signal's reach and penetration. Beam Management Beam management refers to the set of procedures and protocols designed to ensure the optimal configuration and adaptation of beamforming over time and in dynamic conditions. Given the highly directional nature of beams in 5G networks, especially in the upper Sub-6 GHz and higher frequency bands, maintaining an efficient and reliable connection requires continuous monitoring and adjustment of the beams to align with the changing positions and radio conditions of mobile users. Beam management involves several key functions, including: beam sweeping, beam selection, beam refinement, etc. Beam sweeping is the process of systematically directing beams in different directions to explore and identify the best path for communication. This is used in initial access and beam alignment, helping to establish the connection between the user equipment (UE) and the network. Based on measurements and feedback, the most suitable beam (or beams) is selected to maximize the communication link's quality and stability between the network and the UE. As users move, the optimal beam path may change, requiring the network to switch the active beam to maintain the best possible connection. Beam switching ensures that the communication link remains robust, even with mobility and varying obstacles in the environment. Fine adjustments to the beam direction and characteristics may be needed to adapt to incremental changes in the user's position or the radio environment, improving the efficiency and performance of the link. Through beamforming and beam management, 5G networks can deliver high-speed, reliable wireless services, overcoming the challenges posed by high-frequency or mmWave propagation and enabling a wide range of applications, from enhanced mobile broadband (eMBB) to mission-critical communications and massive IoT deployments. In at least one embodiment, the energy saving logic 104 can identify energy saving modes that adjust the beamforming or beam management being used.

In at least one embodiment, the energy saving logic 104 of the RAN controller 102 can be separated into radio access network intelligent controller (RICs) in an OPEN Radio Access Network (O-RAN) architecture, such as illustrated in and described with respect to FIG. 2.

FIG. 2 shows an illustrative system 200 corresponding to an Open Radio Access Network (O-RAN) architecture with energy saving logic 104 according to at least one embodiment. In this example, the Open Radio Access Network software community (O-RAN SC) architecture follows the O-RAN alliance defined architecture. The O-RAN standard introduced a radio access network intelligent controller (RIC) and broke out the functionality of the RIC into non-real time actions that processed any delay tolerant actions and near-real time actions that covered any immediate actions. In particular, the non-real time actions are performed by a non-real-time RIC 204 and the near-real time actions are performed by a near-real-time RIC 206.

A RIC is a component within a cellular network architecture, designed to bring intelligence and flexibility to the RAN. The RIC enables more efficient use of network resources, improves network performance, and facilitates the deployment of new services through the orchestration and automation of network functions. The RIC can utilize real-time data analytics and machine learning algorithms to dynamically optimize the RAN. This includes adjusting network parameters for optimal performance, managing interference, and optimizing handovers between cells, thereby enhancing the overall user experience. The RIC can enable policy-driven control of RAN resources, allowing operators to implement network policies that align with business objectives, such as prioritizing certain types of traffic, users, or services to ensure quality of service (QOS) and quality of experience (QoE). The RIC can also manage network slices, which are logically isolated network partitions tailored for specific services or customer needs. The RIC can help in creating, modifying, and terminating slices, ensuring that each slice meets its specific performance, latency, and reliability requirements. As described above, a RIC can be the Near-Real-Time RIC 206 or the Non-Real-Time RIC 204. The Near-Real-Time RIC 206 can operate on a timescale of tens of milliseconds to one second. It is tailored for use cases requiring rapid response times, such as dynamic radio resource management and interference mitigation. The Non-Real-Time RIC 204 can operate on a timescale of one second or longer. The Non-Real-Time RIC 204 can focus on longer-term RAN optimization and policy management, including predictive analysis and planning based on historical data.

The system 200 may include a service management and orchestration framework SMO 202, which may interface with other components of the system 200, such as, an Open Cloud Open Cloud (O-Cloud) 218 and the near-real-time RIC 206. SMO 202 may further include the non-real-time RIC 204. In some implementations, near-real-time RIC 206 may further communicate with an evolved NodeB (O-eNB) 208, which in some implementations corresponds to the hardware aspect of a 4G radio access network. Near-real-time RIC 206 also further interfaces with centralized units (CU), including an open centralized unit-control plane node (O-CU-CP) 210 and an open centralized unit-user plane node (O-CU-UP) 212, as well as an open distributed unit (O-DU) 214, and an open radio unit (O-RU) 216, as further shown in FIG. 2. Since the non-real-time RIC 204 handles the delayed tolerant applications, the non-real-time RIC 204 can communicate using the O1 interface. As shown in FIG. 2, the O1 interface is not delay sensitive, whereas the near-real-time RIC 206 is configured to control time sensitive applications and uses the E2 network interface for time-sensitive applications. In various embodiments, the technology of this disclosure may focus upon communications and interactions between O-DU 214, O-CU-CP 210, and/or O-CU-UP 212. FIG. 2 also further illustrates how system 200 may further include a multitude of communication lines interconnecting various ones of the components outlined above.

In the context of FIG. 2, radio access network (e.g., gNB, gNodeB, or base station) disaggregation corresponds to an initial phase of the deployment of Fifth Generation (5G) technology, and a major application will be Enhanced Mobile Broadband (eMMB). Radio access network disaggregation can be performed according to the 3rd Generation Partnership Project (3GPP) or according to the O-RAN specification illustrated in the illustrative example of FIG. 2.

In at least one embodiment, the non-real-time RIC 204 can perform long-term three-domain (3D) analysis and the near-real-time RIC 206 can perform mid/short term 3D analysis to determine energy saving modes and policies in terms of longer and short terms. For the long-term analysis by the non-real-time RIC 204, the non-real-time RIC 204 can collect statistical data for the number of active UEs and the traffic per time, carrier, band, and beam. The non-real-time RIC 204 can determine a specified time (T domain), such as at an hour level, what carrier/band (F domain), and what transceiver (TRx) chain and beam for which energy saving mode based on the collected data. The non-real-time RIC 204 can apply the determined energy saving mode in the specified time (T domain) decided for the part of the carrier/band's antenna/beam (F and S domains). The non-real-time RIC 204 can compensate the reduced target cell coverage through rebalancing the UE traffic to neighboring carrier/band (F domain) or adjust the beam (S domain) of neighboring cells.

For the mid-term analysis by the near-real-time RIC 206, the near-real-time RIC 206 can apply which slot (T domain) and which transceiver (TRx) chain/beams (S domain) to be an energy saving mode based on the scheduled information collected. The near-real-time RIC 206 can create an empty slot (T domain) by adjusting Synchronization Signal Block (SSB) duration and scheduling priority or create an empty beam (S domain) by beam management. The SSB contains information that enables UEs to detect the presence of a 5G/6G network, synchronize with it in time and frequency, and obtain the necessary parameters to proceed with system access. The near-real-time RIC 206 can apply an energy saving mode for the empty slots (T domain) and/or the empty beams (S domain).

The RU may internally have the RF components or the capabilities to support short-term energy saving (T-domain, such as at a OFDM symbol-level). These RU capabilities are advertised on the SMO 202 and the non-real-time RIC 204 or the near-real-time RIC 206 can determine whether to enable such capabilities in the RU. When these RU capabilities are enabled, the RU independently measures the I/Q signal power at the OFDM symbol-level in real time, adjusts the input current of power amplifies (PAs) accordingly, and optimizes Digital Pre-Distortion (DPD) to obtain an energy saving gain at the RF component level. DPD optimization refers to a signal processing technique used to improve the performance and efficiency of wireless communication systems, particularly in the context of PAs within transmitters.

The non-real-time RIC 204 and/or near-real-time RIC 206 can perform other coverage compensation operations for reducing energy consumption while maintaining performance of the network. These coverage compensation operations can be done in the T, F, and/or S domains as described below.

In at least one embodiment, the non-real-time RIC 204 and/or near-real-time RIC 206 can cause an RU to be turned off for a period of time in the time (T) domain. While the RU is turned off for a period of time, the non-real-time RIC 204 and/or near-real-time RIC 206 can compensate coverage by making beam adjustments of neighboring cells' mMIMO RU to cover the target cells' direction or coverage area. While the RU is turned off for a period of time, the non-real-time RIC 204 and/or near-real-time RIC 206 can cause utilization of smaller cells in heterogenous RAN environments. While the RU is turned off for a period of time, the non-real-time RIC 204 and/or near-real-time RIC 206 can adjust the coverage enhancement features of neighboring cells' DU/RU.

In at least one embodiment, the non-real-time RIC 204 and/or near-real-time RIC 206 can cause an RU to turn off a set of carriers or bands in the frequency (F) domain. For example, the non-real-time RIC 204 and/or near-real-time RIC 206 can preferentially turn off carrier/bands with higher frequencies or lower Effective Isotropic Radiated Power (EIRP) since they have less impact on coverage. While the set of carrier/band is turned off for a period of time, the non-real-time RIC 204 and/or near-real-time RIC 206 can adjust the coverage enhancement features for the target cell's remaining carriers/bands.

In at least one embodiment, the non-real-time RIC 204 and/or near-real-time RIC 206 can cause an RU to turn off a set of mMIMO antennas in the space (S) domain. For example, the non-real-time RIC 204 and/or near-real-time RIC 206 can adjust the antenna for vertical beams (e.g., in a rural area), horizontal beams (e.g., in a building area within indoor coverage) based on the UE distribution and morphology. The non-real-time RIC 204 and/or near-real-time RIC 206 can adjust the beam weight so that the number of working beams is reduced and the beam gain is increased. The non-real-time RIC 204 and/or near-real-time RIC 206 can adjust the coverage enhancement features of the target RU's and/or the neighboring cell's DU/RU.

In at least one embodiment, the non-real-time RIC 204 and/or near-real-time RIC 206 can use the following coverage control parameters, such as downlink (DL) and uplink (UL) coverage enhancement configurations, to achieve energy savings in the network while maintaining network performance. In at least one embodiment, the DL coverage enhancements can include adjustments to enable and/or modify the configurations of DL coverage related features, such as DL Cooperative Multi-Point (DL COMP) transmission, Multiple Transmission Reception Point (mTRP) transmission, Resource Element (RE) power boosting, or the like.

DL COMP transmission is a communication technique used in cellular networks to improve signal quality and increase throughput, especially at cell edges where users may experience poor signal strength due to interference from neighboring cells. This technology involves the coordination of signal transmission from multiple base stations or cell sites to a single user equipment (UE) in a synchronized manner, effectively increasing the signal strength and reducing the impact of interference. The main principle behind DL COMP is to turn what would traditionally be interfering signals from neighboring cells into useful signals that can enhance the overall signal quality received by a UE. This is achieved through precise timing, phase adjustment, and power control of the signals transmitted from different cells. The energy saving logic 104 can use DL COMP transmission to compensate for coverage in the energy saving modes.

Multiple Transmission Reception Point (mTRP) transmission is a technology for enhancing signal reliability, network capacity, and user experience through the use of multiple transmitters and receivers distributed across different geographical locations. By leveraging signals from multiple transmission and reception points, mTRP can significantly improve the signal-to-noise ratio (SNR) at the user equipment (UE). This results in better signal quality, faster data rates, and lower bit error rates. By utilizing multiple points for transmission and reception, mTRP can extend the reach of the network to areas that might be challenging to cover through traditional single-point transmission, such as indoor environments or densely populated urban areas with numerous obstructions. The energy saving logic 104 can use mTRP to compensate for coverage in the energy saving modes.

Resource Element (RE) power boosting is a technique for enhancing the signal strength of specific resource elements within a transmission time interval. A Resource Element is the smallest unit of resources in the frame structures, comprising one subcarrier in frequency and one symbol in time. Power boosting is applied to certain signal components or channels, such as control signals, reference signals, or specific data channels that are deemed essential for establishing and maintaining reliable communication between the base station (eNB or gNB) and user equipment (UE). By increasing the power level of these selected REs relative to the rest of the transmission, the technique aims to: improve signal reliability, facilitate access and mobility, and enable coverage extension. By boosting the power of specific REs, the energy saving logic 104 can extend the coverage of essential signals, reaching UEs located beyond the edge of the cell. Power boosting can also be used to support advanced features and services, such as beamforming in massive MIMO configurations, where it can be used for directing signal power towards specific UEs to improve the efficiency and performance of the wireless link. The energy saving logic 104 can use RE power boosting to compensate for coverage in the energy saving modes.

In at least one embodiment, the DL coverage enhancement configurations can include adjustments to the Physical Downlink Control Channel (PDCCH), such as increasing an aggregation level, enabling Control Channel Element (CCE) power boosting, enabling wideband precoding, or the like.

The energy saving logic 104 can increase an aggregation level by a process of augmenting the number of resource units, such as Resource Blocks (RBs) or Resource Units (RUs), that are bundled together to form a larger scheduling unit for data transmission.

Control Channel Element (CCE) power boosting is a technique for improving the reliability of control information transmission between the base station and user equipment (UE). A Control Channel Element is a unit used for scheduling and control information in cellular networks. By increasing the power level of CCEs relative to other channel elements, this the reception quality of crucial control signals is enhanced, such as scheduling assignments, Hybrid Automatic Repeat Request (HARQ) information, and channel quality indicators. The energy saving logic 104 can use CCE power boosting to compensate for coverage in the energy saving modes.

Wideband precoding is a signal processing technique for enhancing signal transmission across a broad range of frequencies. This technique involves the customization of the transmission signal at the transmitter side, based on the known characteristics of the communication channel, to maximize signal reception quality and efficiency across the entire bandwidth of interest. The energy saving logic 104 can use wideband precoding to compensate for coverage in the energy saving modes.

In at least one embodiment, the DL coverage enhancement configurations can include adjustments to the Physical Downlink Shared Channel (PDSCH), such as using repetition or increasing repetition, or the like.

The Physical Downlink Shared Channel (PDSCH) is utilized for transmitting user data and some types of control information from the base station to the user equipment (UE). Using repetition or increasing the repetition for signals on the PDSCH is a strategy to enhance signal reliability, especially in scenarios where transmission conditions are poor or for UEs located at the edge of the cell coverage or in areas prone to high interference. The energy saving logic 104 can make adjustments to the PDSCH to compensate for coverage in the energy saving modes.

In at least one embodiment, the DL coverage enhancement configurations can include adjustments to the SSB, such as changing the pattern, increasing repetition, or the like. The SSB facilitates initial access and synchronization of devices to the network. The primary function of the SSB is to enable initial access and cell search procedures. When a UE is powered on, it searches for SSBs to synchronize with the network, decode the Master Information Block (MIB), and proceed with the connection establishment process. The SSB includes a set of signals used by UEs to detect the presence of a 5G network, identify the network's frequency and frame structure, and achieve time and frequency synchronization with the network. The SSB contains two main elements: the Primary Synchronization Signal (PSS) and the Secondary Synchronization Signal (SSS). Together, these signals allow a device to determine the Physical Cell ID (PCI) and establish a connection with the cell. Additionally, the SSB includes the Physical Broadcast Channel (PBCH), which carries essential system information required by the device to access the network successfully. SSBs are broadcast periodically across the network's coverage area, ensuring that devices can quickly locate a signal and initiate a connection whenever they are powered on or move within the network. Multiple SSBs can be transmitted in different directions (beam sweeping) to ensure that UEs in various locations can detect at least one SSB. Changing the pattern or increasing the repetition of the SSB pertains to how frequently these signals are broadcast and how they are arranged within the frequency and time domains of the network. These adjustments can have significant impacts on network performance, device connectivity, and overall system efficiency, especially in diverse scenarios ranging from dense urban environments to widespread rural areas. For example, the distribution and transmission strategy of SSBs in terms of the placement across the frequency band and over time can be modified. Changing the pattern could involve adjusting the SSB periodicity, which impacts how often SSBs are transmitted, or altering the frequency positions of SSBs to enhance signal detection and initial access in various signal conditions. For instance, in areas with significant obstructions or in scenarios where devices experience high mobility, a more dispersed pattern might facilitate better and faster network discovery by mobile devices. Increasing the repetition involves broadcasting SSBs more frequently within a given time period or across the frequency spectrum. This enhancement can improve a device's ability to detect the network under challenging conditions, such as in low signal scenarios, at cell edges, or in high interference environments. Higher repetition rates can lead to quicker initial access and improved reliability for devices attempting to connect to the network, albeit at the cost of consuming more network resources and potentially reducing overall spectral efficiency. These adjustments can be used for optimizing 5G network performance and accessibility. The energy saving logic 104 can dynamically configure SSB patterns and repetition rates based on a variety of factors, including user density, mobility patterns, geographic and structural variances in the served areas, and the specific requirements of different use cases, such as enhanced Mobile Broadband (eMBB), Ultra-Reliable and Low Latency Communications (URLLC), and massive Machine Type Communications (mMTC).

In at least one embodiment, the UL coverage enhancements can include adjustments to enable and/or modify the configurations of UL coverage related features, such as UL Cooperative Multi-Point (UL COMP) reception, mTRP reception, UE's dynamic power aggregation, or the like.

UL COMP reception is a technique designed to enhance the uplink signal quality of user equipment (UE) in wireless communication networks. This is achieved by coordinating the reception between the UE and multiple receiving points, typically base stations, or remote radio heads. The main objectives of UL COMP are to increase the uplink data rate, reduce transmission delay, and improve the overall reliability of the communication link, especially at cell edges where signal quality tends to degrade. In UL COMP, signals transmitted by the UE are received by multiple coordinated receiving points. These signals are then combined or processed in a manner that maximizes the signal quality. The energy saving logic 104 can use UL COMP reception to compensate for coverage in the energy saving modes.

As described above, mTRP reception is a technology for enhancing signal reliability, network capacity, and user experience through the use of multiple transmitters and receivers distributed across different geographical locations. By leveraging signals from multiple transmission and reception points, mTRP can significantly improve the SNR at the UE. This results in better signal quality, faster data rates, and lower bit error rates. By utilizing multiple points for transmission and reception, mTRP can extend the reach of the network to areas that might be challenging to cover through traditional single-point transmission, such as indoor environments or densely populated urban areas with numerous obstructions. The energy saving logic 104 can use mTRP to compensate for coverage in the energy saving modes.

UE's dynamic power aggregation is a technical approach focused on optimizing the power usage of UE in wireless communication systems by dynamically aggregating and managing power resources based on the current operating conditions, user demand, and network constraints. This technique involves intelligently combining available power sources, adjusting power levels, and employing power-saving mechanisms to enhance the energy efficiency of the UE while maintaining or improving the communication performance. Dynamic power aggregation operates under the principle of adapting the UE's power utilization in real-time, taking into account factors such as signal quality, battery life, data rate requirements, and network conditions. The energy saving logic 104 can use the UE's dynamic power aggregation to compensate for coverage in the energy saving modes.

In at least one embodiment, the UL coverage enhancement configurations can include adjustments to the Physical Random Access Channel (PRACH), such as a long coverage format change, repetition, or increasing repetition, or the like. PRACH enables UEs to initiate communication with the network. PRACH serves as the channel through which UEs can send a preliminary signal, known as a preamble, to the base station (BS) or NodeB, signaling their intention to establish a connection. This initial signaling is essential for a range of operations such as initial system access, synchronization, registration, and to facilitate subsequent dedicated resource assignments for communication. The Long Coverage Format Change in the context of PRACH refers to an adaptation of the preamble format used by UEs to initiate communication with the network, specifically designed to enhance performance in extended coverage conditions. This format change aims to increase the range and reliability of initial access requests under challenging network conditions, such as at the edges of cell coverage or in rural areas. Repetition involves sending the same PRACH preamble multiple times. Increasing repetition in the context of PRACH involves transmitting the PRACH preamble multiple times to improve the likelihood of successful reception by the gNB. This technique enhances the reliability of the random access procedure, particularly in challenging radio environments, by improving SNR, reducing collisions, and increasing the access success rate. The energy saving logic 104 can use adjustments to PRACH to compensate for coverage in the energy saving modes.

In at least one embodiment, the UL coverage enhancement configurations can include adjustments to the Physical Uplink Control Channel (PUCCH), such as a long coverage format change, repetition, Demodulation Reference Signal Bundling (DMRS), or the like. PUCCH is a dedicated channel used for the transmission of control information from User Equipment (UE) to the network base station. Control information sent over the PUCCH includes but is not limited to scheduling requests, Hybrid Automatic Repeat Request (HARQ) acknowledgments, Channel Quality Indicator (CQI) reports, and other vital signaling necessary for optimizing network performance and resource allocation. Long format change in the context of PUCCH refers to the adaptation to longer PUCCH formats (2, 3, and 4) to handle larger amounts of control information and meet specific transmission requirements in 5G NR. This approach increases the payload capacity, extends the transmission duration, and enhances the reliability of control information delivery. It provides flexibility and improved performance in various use cases, although it introduces additional complexity and requires careful resource management. Increasing repetition refers to the technique of transmitting the same control information multiple times to enhance the reliability and robustness of the communication, particularly in challenging radio environments. This method is used to improve the probability of successful reception at the gNB (base station) by combating issues such as interference, signal fading, and weak signal conditions. DMRS bundling in the context of PUCCH is a technique used to enhance the reliability and accuracy of channel estimation for control information transmission. DMRS can enable the receiver at the base station (gNB) to accurately decode the transmitted signals by providing reference points for channel estimation. The energy saving logic 104 can use adjustments to PUCCH to compensate for coverage in the energy saving modes.

In at least one embodiment, the UL coverage enhancement configurations can include adjustments to the Physical Uplink Shared Channel (PUSCH), such as repetition, increase of repetition, DMRS bundling, Transport Block over Multiple Slots (TBoMS), or the like. PUSCH is responsible for carrying user data from the UE to the base station (gNB), enabling efficient and reliable uplink data transmission. Increasing repetition in the context of PUSCH refers to the technique of transmitting the same data multiple times to enhance the reliability and robustness of data transmission from the UE to base station. This approach is particularly useful in challenging radio environments where signal degradation, interference, or high mobility could affect the quality of the transmission. DRMS bundling in the context of the PUSCH refers to the practice of transmitting multiple DMRS within a PUSCH transmission to enhance channel estimation accuracy. DMRS are known reference signals inserted within data transmissions to help the receiver (gNB) accurately estimate the channel conditions and decode the transmitted data. TBoMS refers to a technique where a single transport block (TB) is transmitted over multiple time slots. This approach is used to enhance reliability, improve flexibility in resource allocation, and support various service requirements, especially for applications requiring larger data payloads or operating under challenging radio conditions. The energy saving logic 104 can use adjustments to PUSCH to compensate for coverage in the energy saving modes.

In some embodiments, the energy saving logic 104 can be implemented in one or more RIC applications controlled via a RIC platform in the context of a telecommunications network where the RIC is able to communicate with the platform extension and adapters to provide network functions for different vendors services. Historically, a RAN intelligent controller (RIC) was a software-defined component of the Open Radio Access Network (O-RAN) that was responsible for controlling and optimizing RAN functions. The O-RAN set a standard for virtual RAN run on standard servers. Historically, the RIC was able to service commercial vendors using the network resources available on the RIC, however, the RIC was unable to efficiently use resources in a way that allowed for multiple vendors to use redundant resources efficiently. In one example, the RIC platform is a non-real time RIC and the network function includes the energy saving logic 104. In one example, the RIC platform is a near-real time RIC and the network function is a time-sensitive network function. In at least one embodiment, a first dedicated network controller implements a first portion of the energy saving logic 104 and a second dedicated network controller implements a second portion of the energy saving logic 104. In one example, the first dedicated network controller is a first dedicated rApplication (rAPP) and the second dedicated network controller is a second dedicated rAPP of the non-real time RIC. In one example, the first dedicated network controller is a first dedicated xApplication (xAPP) and the second dedicated network controller is a second dedicated xAPP of the near-real time RIC. In one example, the first dedicated network controller is a first dedicated xAPP and the second dedicated network controller is a second dedicated RAPP of the near-real time RIC. In one example, the first private network and the second private network operate simultaneously on the RIC platform.

In at least one embodiment, long-term decisions can be made by the non-real-time RIC 204. Based on statistical data collection for the number of active UEs and the traffic per time/carrier/band/beam, the non-real-time RIC 204 can decide when (T: hour-level), what carrier/band (F), what antenna/beam (S) for an energy saving mode. The non-real-time RIC 204 can perform one or more actions, including applying the decided energy saving mode in the time decided (T: hour-level) for the part of carrier/band's antenna/beam (F×S). The non-real-time RIC 204 can also perform additional operations for compensation. The non-real-time RIC 204 can perform coverage replacement through rebalancing the carrier/band (F) of small UE/traffic to neighboring carrier/band (F) or adjusting the beam (S) of neighboring cells.

In at least one embodiment, mid-term decisions can be made by the near-real-time RIC 206. The near-real-time RIC 206 can apply which slot (T) and which antenna/beam (S) to be in an energy saving mode based on the scheduling information collection. The near-real-time RIC 206 can perform one or more actions, including applying the decided energy saving mode by creating an empty slot (T) by adjusting SSB duration and scheduling priority or create empty beam (S) by beam management.

In at least one embodiment, short-term decisions can be made by an RU based on the RU capability. The near-real-time RIC 206 can determine whether to enable energy saving modes at the RU and the RU itself can decide an energy saving mode through its RF components' acting characteristics (S) and I/Q power sensing (T: symbol-level) without the DU/scheduler's action. The RU can perform one or more actions to achieve energy savings through measuring symbol level I/Q transmit power in real-time and following DPD optimization and adjusting PA input current.

In at least one embodiment, there are various adjustments that can implement the energy saving mode, including: whole RU turn-off for a period of time (T) (i.e., turning off all TRx chains including the DFE); beam adjustment of the neighboring cells' mMIMO RU to the target cell's direction/coverage; distributing the traffic load to the sub-cells for mMIMO energy saving in heterogeneous RAN environments; adjusting the coverage enhancement configuration of neighboring cells' DU/RU; turning-off a set of carrier/band (F); turning-off from the carrier/band of smaller PSD or higher frequencies that have less coverage; adjusting the coverage enhancement for the target cell's remaining carrier/band; turning-off a set of mMIMO transceiver (TRx) chains (S) (Tx/Rx path); adjusting first the antenna for vertical beam (rural area), horizontal beam (building area within indoor coverage) based on the cell condition; adjusting the beam weight so that the number of working beam is reduced and the beam gain is increased; adjusting the coverage enhancement of target/neighboring cells' DU/RU; and the like. Also, various coverage enhancement configurations can be used, such as DL COMP, mTRP transmit, RE power boosting; PDCCH: increase of aggregation level, CCE power boosting, wideband precoding; PDSCH: repetition, increase of repetition; SSB: pattern change (increase of repetition); UL coverage enhancement configuration; UL CoMP/mTRP reception, UE's dynamic power aggregation; PRACH: long coverage format change, repetition; PUCCH: long coverage format change, repetition, DMRS bundling; PUSCH: repetition, increase of repetition, DMRS bundling, TBoMS; and the like.

This application also further discloses a non-transitory computer-readable medium encoded with instructions that, when executed by a physical processor of a computing device, cause the computing device to perform the method of one or more embodiments of the method outlined above. This application also further discloses a system configured to perform one or more of the embodiments outlined above.

In some implementations, a system (e.g., system 100 in FIG. 1A, or system 200 in FIG. 2) may include a computing system to facilitate a cellular network (e.g., the cellular network 120 in FIG. 1A, or system 200 in FIG. 2), the computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not-and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 200 in FIG. 1A, or system 1000 in FIG. 2) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to the functionality described herein.

As described above, cellular networks can use mMIMO systems. However, the candidate spectrum for the 6G technology includes an upper mid-band between 7 and 24 GHz. Due to the higher frequency of this range, as compared to 5G, the 6G coverage will be significantly reduced. Therefore, coverage enhancement technologies are needed. The 6G technology's throughput requirement is more than ten times than 5G technology's throughput. To achieve the higher throughput, Extreme massive MIMO (extreme mMIMO) systems can be used. The higher frequency band in 6G can have a higher pathloss than in 5G, higher power amplifiers would be required. In addition, the number of transceivers would increase.

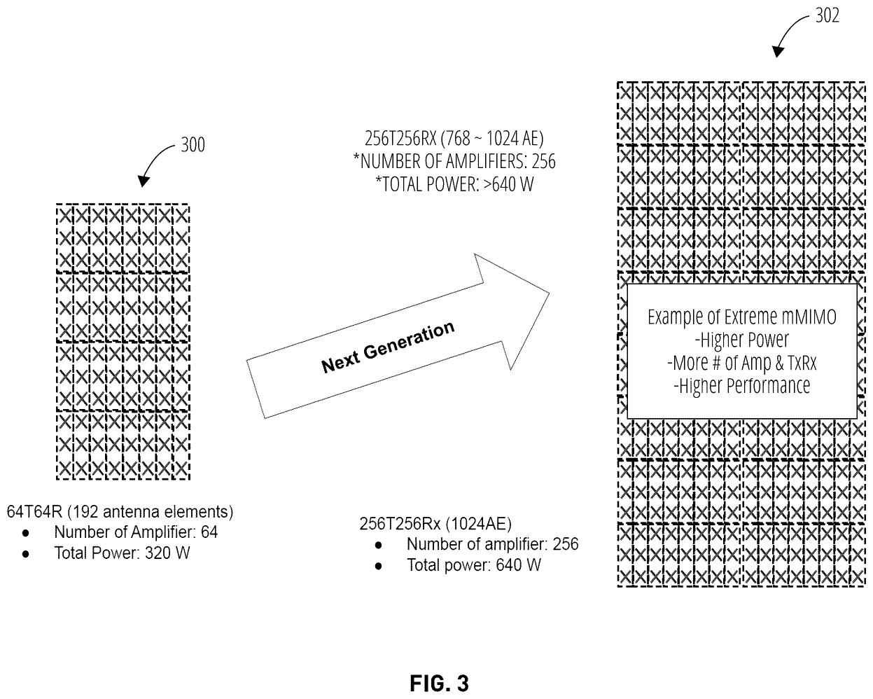

FIG. 3 illustrates an example of a mMIMO system 300 and an extreme mMIMO system 302 according to at least one embodiment. The massive MIMO system 300 can include multiple transceiver chains (TRx chains), including Low Physical (PHY), eCPRI Interface, a Digital Front End (DFE) (e.g., Compact Radio Frequency (CRF), Digital Pre-Distortion (DPD)), radio frequency integrated circuit (RFIC) (e.g., analog-to-digital and digital-to-analog converters, up or down converters (Up/Dn converter), amplifiers, and antennal elements. The mMIMO system 300 can include 192 antenna elements with 64 transceiver chains with power amplification with a total power of 320 watts (W). The extreme mMIMO system 302 can include 1024 antenna elements with 256 transceiver chains (TRx chains) with power amplification with a total power greater than 640 W. As illustrated in FIG. 3, the extreme mMIMO system 302 can have higher power, more amplifiers, transceiver, and antenna elements to achieve higher performance. The energy saving logic 104 can be used in either the mMIMO system 300 or the extreme mMIMO system 302, but the energy saving logic 104 can benefit the extreme mMIMO system 302 more than the mMIMO system 300 because of the higher power consumption by the extreme mMIMO system 302 as compared to the mMIMO system 300.

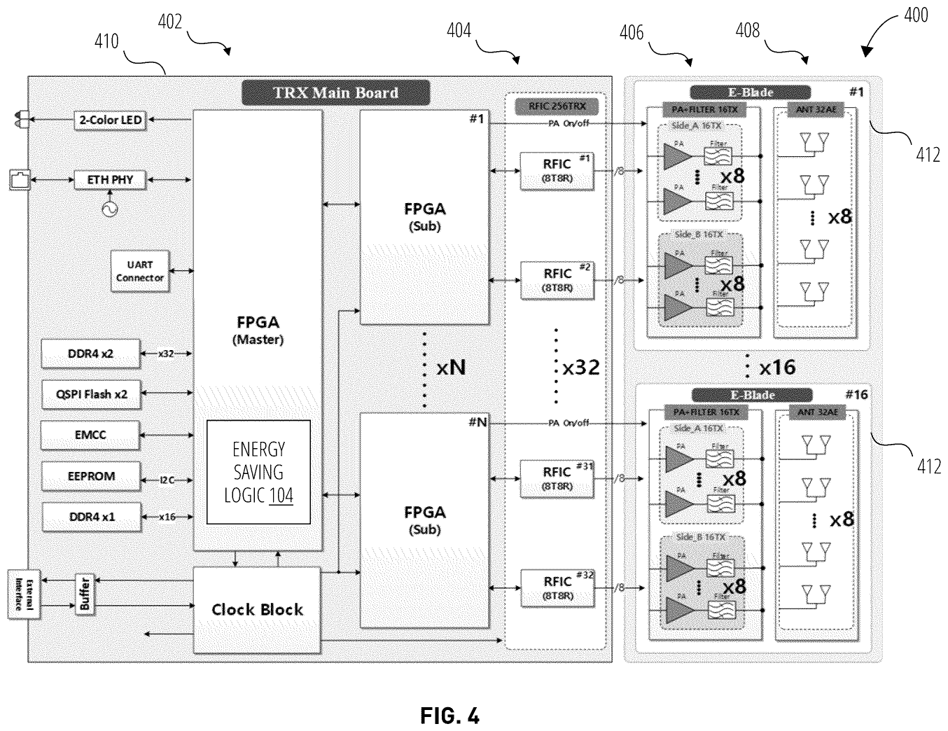

FIG. 4 is a block diagram of an example extreme mMIMO system 400 according to at least one embodiment. The extreme mMIMO system 400 can include a Digital Front End (DFE) 402, RFICs 404, amplifiers 406, and antenna elements 408. The DFE 402 can include a primary FPGA and multiple secondary FPGAs, as illustrated in FIG. 4. Each secondary FPGA can be coupled to multiple RFICs 404. For example, N number of secondary FPGAs can be coupled to 32 RFICs 404, each RFIC 404 having eight outputs coupled to one of multiple e-blades 412 described below. Each of the RFICs 404 is coupled to multiple amplifiers 406, each of the amplifiers 406 being coupled to one or more antenna elements 408. The RFICs 404 can include ADCs and DACs, up converters, down converters, etc. The DFE 402 can implement CRF, DPD, or other functions in the digital domain.

The DFE 402 and RFICs 404 can be located on a main circuit board 410. The amplifiers 406 and antenna elements 408 can be located on multiple e-blades 412. An e-blade refers to a compact, modular, and high-performance antenna module of antenna arrays used in advanced wireless communication technologies such as 5G, 6G, and beyond. For example, one of the e-blades 412 includes a first side with 8 TX chains, each TX chain including a power amplifier and a filter, and a second side with 8 TX chains, each TX chain including a power amplifier and a filter. Each of the e-blades 412 includes 8 antenna arrays with cross polarization, each antenna array including 4 antenna elements. The extreme mMIMO system 400 can include other circuits, such as a clock block to synchronize operations of the DFE 402, memory, interfaces, etc.

In this embodiment, the extreme mMIMO system 400 includes 1024 antenna elements 408 and 256 TRx chains on 16 e-blades 412, each e-blades having 16 TRx chains, each TRx chain having a power amplifier 406 and a filter. In other embodiments, other number of antenna elements 408 and TRx chains can be achieved.

In at least one embodiment, the energy saving logic 104 can be used in the extreme mMIMO system 400. In one embodiment, the energy saving logic 104 is implemented in the logic of the DFE 402, such as the primary FPGA as illustrated in FIG. 4. In other embodiments, an external controller can control the operations of the extreme mMIMO system 400 according to the energy savings mode. The energy saving logic 104 can control different aspects of the extreme mMIMO system 400 to adjust parameters in the T, F, or S domains as described herein. In at least one embodiment, the RU can be turned off for a period of time in the T domain. The energy saving logic 104 can make beam adjustments of the neighboring cells mMIMO RU to the target cells' direction for coverage when the RU is turned off for the period. The energy saving logic 104 can utilize small cells in heterogeneous RAN environments when the RU is turned off for the period. The energy saving logic 104 can adjust the coverage enhancement features of neighboring cell's DU/RU as well. In other embodiments, the energy saving logic 104 can turn off a set of carriers or frequency bands in the F domain. The energy saving logic 104 can turn off from the carrier/band of smaller PSDs (Power Spectral Densities) or higher frequencies that have less coverage. The energy saving logic 104 can adjust the coverage enhancement features of the target cell's remaining carrier/band as well. In other embodiments, the energy saving logic 104 can turn off a set of mMIMO antennas in the space domain (S). The energy saving logic 104 can adjust first the antenna for a vertical beam (rural area), a horizontal beam (building area within indoor coverage) based on the cell condition. The energy saving logic 104 can adjust the beam weight so that the number of working beam is reduced and the beam gain is increased. The energy saving logic 104 can adjust the coverage enhancement features of the target/neighboring cell's DU/RU as well.

In at least one embodiment, the energy saving logic 104 can receive morphology data and traffic pattern data. The traffic patterns can vary depending on the morphology. This data may include traffic load of user equipment (UE) traffic data, a UE signal-to-noise (SNR), a UE Receive Signal Strength Indicator (RSSI), a UE Channel State Information (CSI), a number of UEs, a resource block (RB) usage rate, a type of traffic (e.g., voice, data, etc.), or morphology information. In the context of cellular networks, morphology information refers to the structural characteristics and geographical layout of the physical environment in which the network operates. This information can directly affect how signals propagate through the network. The morphology information can include terrain features, urban features, and vegetation and water bodies. The terrain features can specify elevation changes (hills, valleys, mountains) that may obstruct or reflect signals. The urban infrastructure can specify buildings, streets, and other manufactured structures that can create signal interference, cause reflection, or block the direct line-of-sight between a base station and a mobile device. The vegetation and water bodies can specify trees, forests, lakes, and rivers, which can absorb or reflect radio signals, impacting the quality and range of communication. By incorporating this information, cellular networks can optimize their design and operations, such as adjusting base station placement, antenna configuration, and power management to improve coverage, reduce interference, and ensure a higher quality of service.

In at least one embodiment, the energy saving logic 104, to determine the one or more ES modes can determine output data, such as key performance indicators (KPIs) or other monitored data. For example, energy consumption can be a KPI that is monitored in connection with the ES mode determination. For example, the sector average throughput, peak throughput, a total number of UE, Voice over New Radio Mean Opinion Score (VoNR MOS), latency, handover failure rate, etc., can be monitored in connection with the ES mode determination. The VoNR MOS is a metric used to measure the perceived quality of voice services in 5G networks.

In at least one embodiment, the one or more components include a Radio Unit (RU) with an extreme mMIMO system that supports at least two adjacent frequency bands. The extreme mMIMO system includes a plurality of antenna ports and corresponding amplifiers and transceivers configurable to be turned on or off and weight sets being configurable to adjust a number of beams and a beam width of the number of beams. The energy saving logic 104 can causing the at least one adjustment of the RU with the extreme mMIMO system by configuring a first number of the plurality of antenna ports and corresponding amplifiers and transceivers to be turned on or off in a first ES mode, configuring a first number of beams in the first ES mode, and configuring a first beam width of the number of beams in the first ES mode. The first ES mode can specify an active geometry of the plurality of antenna ports and corresponding amplifiers and transceivers.

In at least one embodiment, the one or more ES modes includes a set of predefined combinations of parameters in the space (S) domain and parameters in the frequency (F) domain. In at least one embodiment, the set of predefined combinations of the parameters in the S and F domains include: i) a first combination with a first number of antenna ports and corresponding amplifiers and transceivers turned on for an upper frequency band and a lower frequency band, the first combination corresponding to a maximum power consumption mode; ii) a second combination comprising the first number of antenna ports and corresponding amplifiers and transceivers turned off for the upper frequency band and the lower frequency band, the second combination corresponding to a minimum power consumption mode of the one or more ES modes; and iii) one or more additional combinations comprising different number of antenna ports and corresponding amplifiers and transceivers turned on for at least one of the upper frequency band or the lower frequency band, the one or more additional combinations corresponding to others of the one or more ES modes. In at least one embodiment, the first number is 256 antenna ports and corresponding amplifiers and transceivers. The first combination can include the 256 antenna ports and corresponding amplifiers and transceivers turned on for the upper frequency band and the lower frequency band, 32 beam weights for each of the upper frequency band and the lower frequency band, two vertical beams with a beam width of 7.5 degrees, and sixteen horizontal beams with the beam width of 7.5 degrees. The second combination can include the 256 antenna ports and corresponding amplifiers and transceivers turned off for the upper frequency band and the lower frequency band. A third combination can include 128 antenna ports and corresponding amplifiers and transceivers turned on for the upper frequency band and the lower frequency band, 16 beam weights for each of the upper frequency band and the lower frequency band, two vertical beams with a beam width of 15 degrees, and eight horizontal beams with the beam width of 15 degrees. A fourth combination can include 64 antenna ports and corresponding amplifiers and transceivers turned on and optimized with lower beams for the upper frequency band and the lower frequency band, 8 beam weights for each of the upper frequency band and the lower frequency band, and eight horizontal beams with the beam width of 15 degrees. A fifth combination can include 128 antenna ports and corresponding amplifiers and transceivers turned on for only the lower frequency band, 16 beam weights for the lower frequency band, two vertical beams with the beam width of 15 degrees, and eight horizontal beams with the beam width of 15 degrees. A sixth combination can include 64 antenna ports and corresponding amplifiers and transceivers turned on for only the lower frequency band, 8 beam weights for the lower frequency band, and eight horizontal beams with the beam width of 15 degrees. A seventh combination can include 32 antenna ports and corresponding amplifiers and transceivers turned on and optimized with limited beams for only the lower frequency band, 4 beam weights for the lower frequency band, and four horizontal beams with the beam width of 30 degrees. Alternatively, other combinations of number of antenna ports and corresponding amplifiers and transceivers, number of beam weights, number of horizontal and vertical beams can vary for any number of predefined combinations.

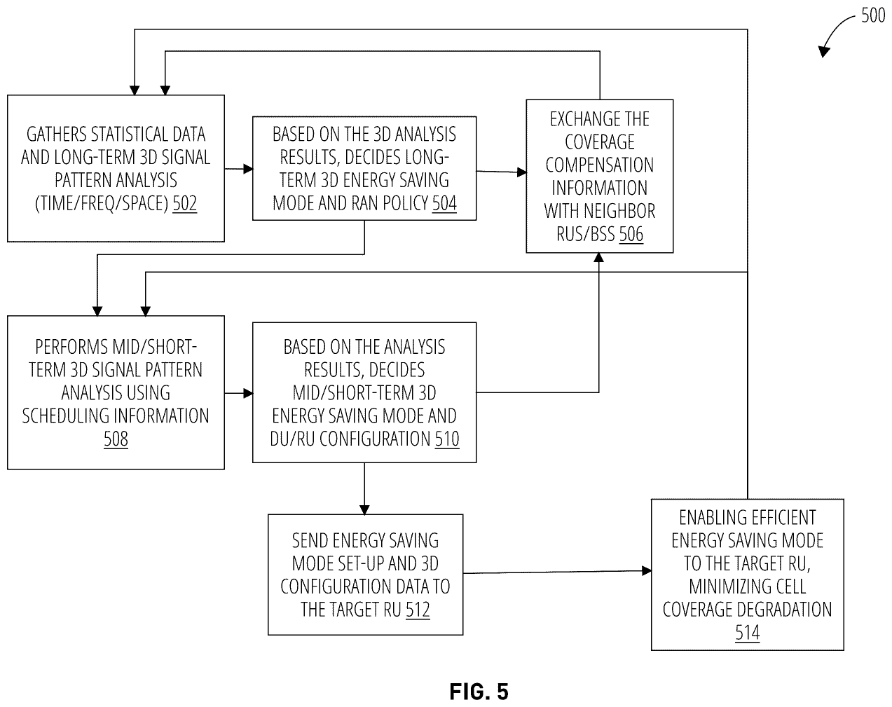

FIG. 5 is a flow diagram of a method 500 for enabling one or more energy saving modes at a target RU according to at least one embodiment. The method 500 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 500 is performed by the RAN controller 102 of FIG. 1A. In at least one embodiment, the method 500 is performed by energy saving logic 104 of FIG. 1A. In at least one embodiment, the method 500 is performed by the DU 127, CU 129, network core 139, or orchestrator 138 of FIG. 1A. In at least one embodiment, the method 500 is performed by the energy saving logic 104 of non-real-time RIC 204 or the energy saving logic 104 of near-real-time RIC 206 of FIG. 2. In another embodiment, the method 500 is performed by a base station or a network core of a cellular network.

Referring to FIG. 5, the method 500 begins with the processing logic (e.g., RAN controller 102 or non-real-time RIC 204) gathers statistical data and long-term three-dimensional (3D) signal pattern analysis in T, F, and S domains (block 502). Based on the 3D analysis results, the processing logic determines a long-term 3D energy saving mode and a RAN policy for the RAN (block 504). The processing logic can exchange coverage compensation information with neighbor RUs/BSs (block 506), and returns to block 502 to continue gathering statistical data and long-term 3D signal pattern analysis. The processing logic (e.g., RAN controller 102 or near-real-time RIC 206) performs mid-term and short-term 3D signal pattern analysis using scheduling information (block 508). Based on the analysis results at block 508, the processing logic determines a mid-term and/or a short-term 3D energy saving mode and DU/RU configuration for the RAN (block 510). The processing logic can exchange coverage compensation information with neighbor RUs/BSs (block 506). The processing logic can send the mid-term and/or short-term 3D energy saving mode and DU/RU configuration to a target RU (block 512). The processing logic can enable the mid-term and/or short-term 3D energy saving mode at the target RU (block 514). The processing logic returns to gathering statistical data and long-term 3D signal pattern analysis in the T, F, and S domains at block 502.

In at least one embodiment, the processing logic can perform long-term 3D analysis and mid/short term 3D analysis to determine energy saving modes and policies in terms of longer and short terms. For the long-term analysis, the processing logic can collect statistical data for the number of active UEs and the traffic per time, carrier, band, and beam. The processing logic can determine a specified time (T domain), such as at an hour level, what carrier/band (F domain), and what antenna path/antenna element/beam for which energy saving mode based on the collected data. The processing logic can apply the determined energy saving mode in the specified time (T domain) decided for the part of the carrier/band's antenna/beam (F and S domains). The processing logic can compensate the reduced target cell coverage through rebalancing the UE traffic to neighboring carrier/band (F domain) or adjust the beam (S domain) of neighboring cells.

For the mid-term analysis, the processing logic can apply which slot (T domain) and which antenna path/antenna element/beams (S domain) to be an energy saving mode based on the scheduled information collected. The processing logic can create an empty slot (T domain) by adjusting Synchronization Signal Block (SSB) duration and scheduling priority or create an empty beam (S domain) by beam management. The SSB contains information that enables UEs to detect the presence of a 5G/6G network, synchronize with it in time and frequency, and obtain the necessary parameters to proceed with system access. The processing logic can apply an energy saving mode for the empty slots (T domain) and/or the empty beams (S domain).

For the short-term analysis based on RU capability, processing logic in the RU itself can determine whether to apply a short-term energy saving mode based on RU capability. The processing logic of the RU itself can determine an energy saving mode through its RF components' acting characteristics (S domain) and I/Q power sensing (T domain, such as at a symbol level) without the DU or scheduler's actions. The RAN can obtain an energy saving gain through measuring symbol level I/Q transmit power in real-time and following Digital Pre-Distortion (DPD) optimization and adjusting power amplifiers (PAs) input current. DPD optimization refers to a signal processing technique used to improve the performance and efficiency of wireless communication systems, particularly in the context of PAs within transmitters.

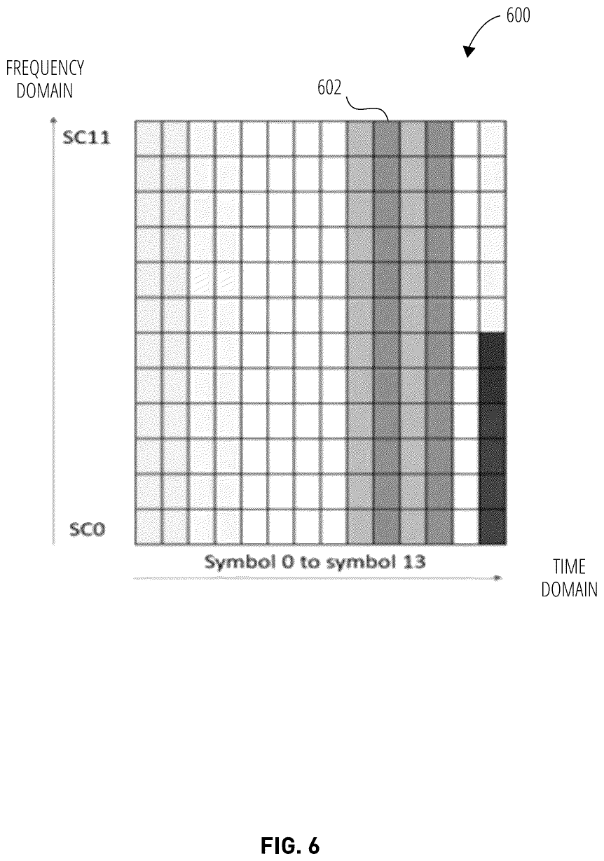

FIG. 6 illustrates an example physical resource block (PRB) 600 transmitted from a node to a first UE according to at least one embodiment. The PRB 600 spans 12 subcarriers (SC0-SC11) corresponding to a frequency (F) domain (e.g., 1130 kHz), and the smallest time-frequency resource that can be scheduled to the first UE is one PRB pair mapped over 14 symbols (Symbol 0-Symbol 13) corresponding to a time (T) domain (e.g., 1 ms for a subframe). The small block in the PRB 600 can be referred to as a resource element, and each resource element corresponds to one subcarrier over one symbol. The PRB 600 includes 168 resource elements. As shown in FIG. 3A, 48 resource elements are used to carry the Synchronization Signal Block (SSB) 602. SSB 602 refers to synchronization signal/physical broadcast channel (PBCH) information because synchronization signal and PBCH information are packed as a single block that transmits together. The synchronization signal may include primary synchronization signal (PSS) and secondary synchronization signal (SSS). The PBCH information may include master information block (MIB). MIB may include the parameters that are required to decode system information type1 (SIB1).

The resource allocation to the UE may include resource allocation in frequency (F) domain (e.g., configured in RRC) for physical uplink shared channel (PUSCH) message and resource allocation in time (T) domain (i.e., scheduling) (e.g., indicated in downlink control information (DCI), where DCI is carried by physical downlink control channel (PDCCH)) for PUSCH message. The parameters characterizing the resource allocation to the UE for uplink transmission may be determined based on the Quality of Service (QOS) requirements, fairness considerations, and overall network load, such that the UE receives a scheduling (time domain) grant that specifies which subframes (frequency domain) it can use for uplink transmission.

In some implementations, the parameters characterizing the resource allocation to the UE for uplink transmission may include uplink received signal strength indicator (RSSI) and uplink signal-to-interference-plus-noise ratio (SINR) in uplink primary resource block (PRB) granularity (per uplink PRB for the involved unlink resource allocation). RSSI and SINR may be used along with conventional radio node vendor implementation (e.g., RSSI and SINR measured by radio node vendor) as a weight factor to determine uplink resource allocation and a value of a power control command described below.

In some implementations, the parameters characterizing the resource allocation to the UE for uplink transmission may include uplink resource allocation of neighboring radio nodes in predetermined coverage zone which can be derived from handover relations and other mobility triggers. For example, the mobility triggers may include the number of handover occurrence and resource usage for such occurrence.

In some implementations, the base station may work as a central entity within the distributed unit of the base station, coordinate with participating neighbor base station(s) involved in uplink primary resource block (PRB) allocation at the same time domain and frequency domain, and coordinate between distributed units of the base station, to ensure the power control command has implemented associated weight factor.

In some implementations, the parameters of a shared channel associated with the base station may include P0 nominal for PUSCH (and also physical uplink control channel (PUCCH)), PRACH initial target receive power, and uplink RSSI in random access channel (RACH) for the determined measurement period.

In some implementations, the parameters of a shared channel associated with the base station may include uplink power control parameters and the base station link adaptation parameters with weight factor based on uplink block error rate (BLER), uplink channel quality, and uplink load across the cluster of identified neighboring radio nodes.

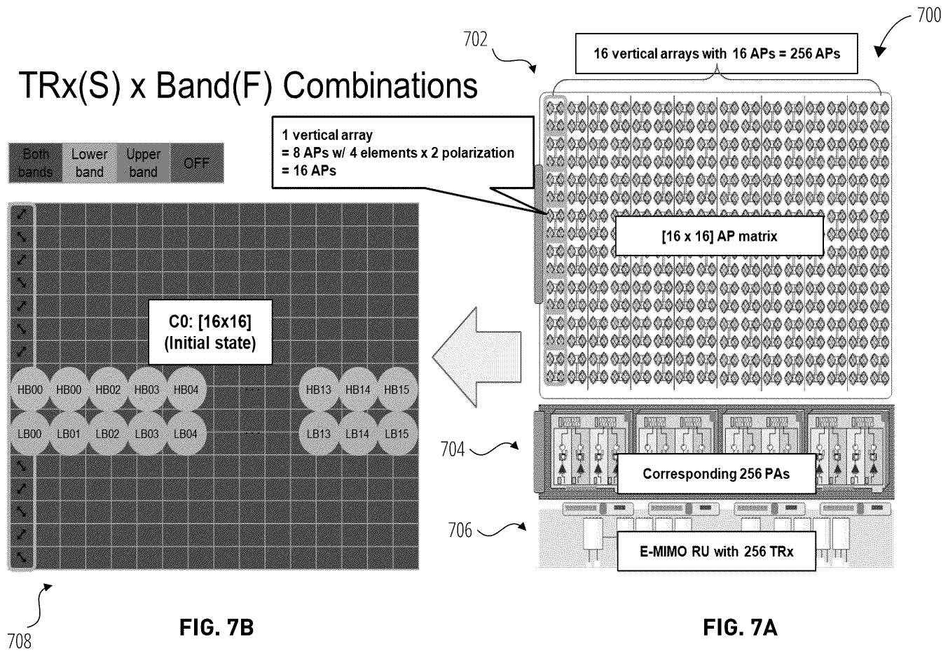

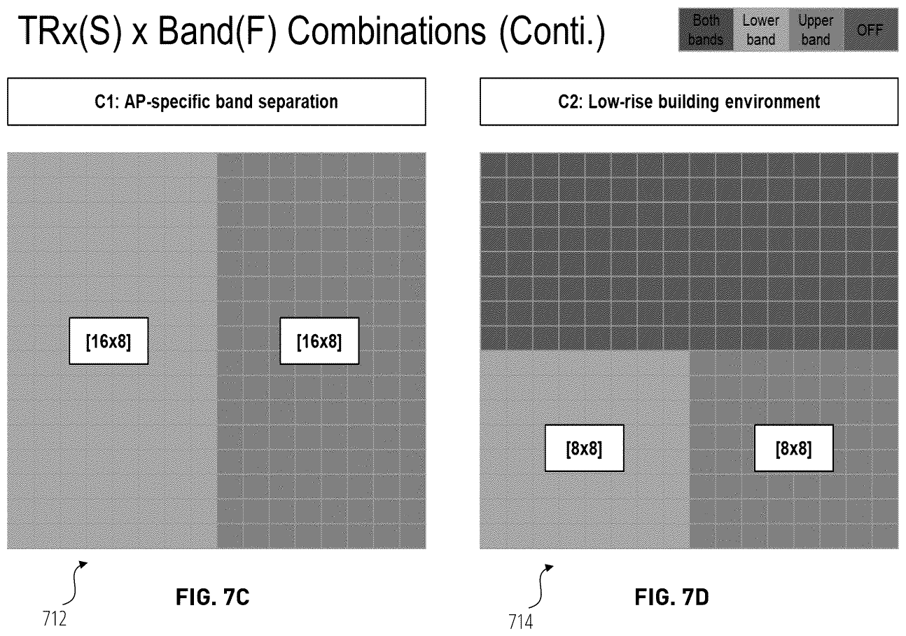

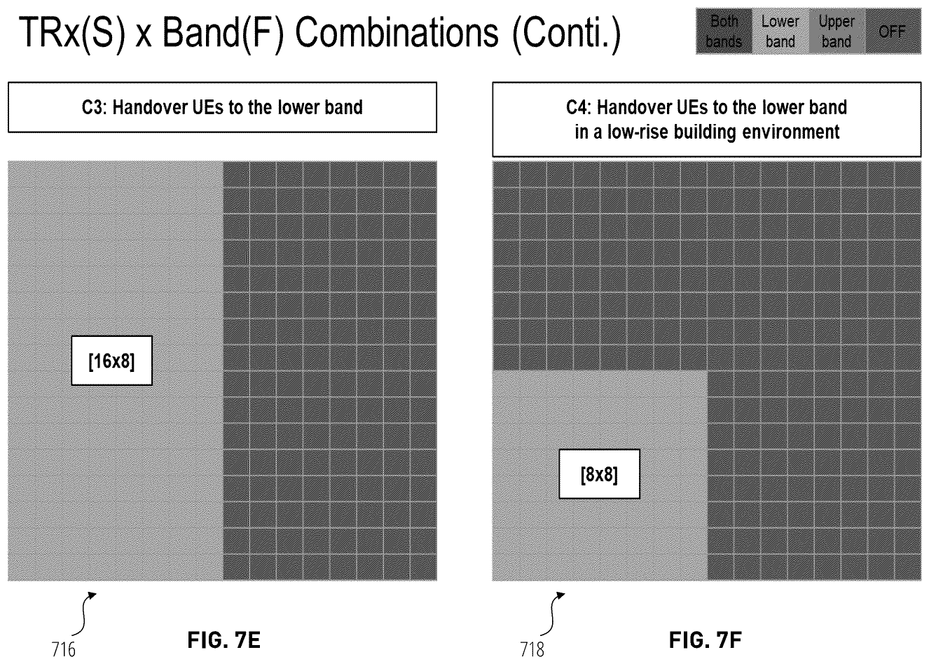

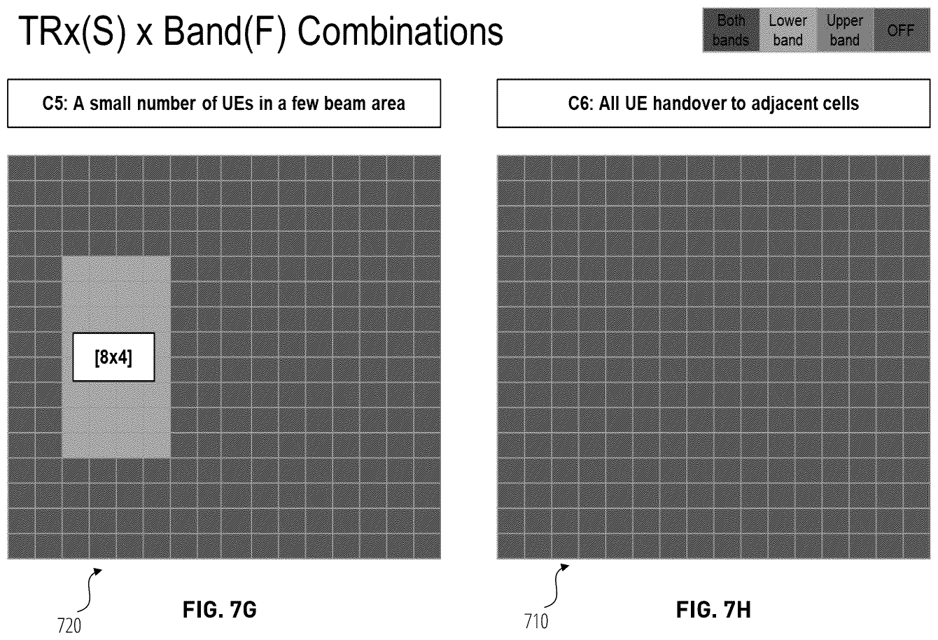

FIG. 7A illustrates an extreme mMIMO system 700 with 256 antenna ports and corresponding amplifiers and transceivers according to at least one embodiment. Each vertical array of the extreme mMIMO system 700 can include eight antenna ports with four antenna elements that can be configured for 2 polarizations, resulting in 16 antenna ports. There are sixteen vertical arrays in the extreme mMIMO system 700, resulting in a 16×16 antenna port (AP) matrix. For the 16×16 AP matrix, there are 256 power amplifiers and 256 transceivers. As described herein, the energy saving logic 104 can control the capabilities of the extreme mMIMO system 700 for different ES modes. In particular, the energy saving logic 104 can control the AP matrix 702, the power amplifiers 704, and transceivers 706 to achieve any combination of transceivers and bands for different ES modes. In this example, there are two frequency bands, including an upper frequency band and a lower frequency band. The energy saving logic 104 can control a number of AP and corresponding power amplifiers 704 and transceivers 706 to turn on or off, a set of beam weights, a number of frequency bands, or the like. Instead of arbitrarily controlling the number of frequency bands, beam weights, and number of frequency bands, the energy saving logic 104 can define a plurality of predefined combinations of parameters in the space (S) domain and parameters in the frequency (F) domain). In this example, the capabilities of the RU's extreme mMIMO system 700 is that each AP of the AP matrix 702 and corresponding power amplifiers 704 and transceivers 706 can be turned on and off and can support two adjacent bands. The extreme mMIMO system 700 can use beam weight sets to adjust beam width and number of beams depending on the active AP/TRx geometry selected for the particular ES mode. The energy saving logic 104 can control these parameters in the frequency (F) and space (S) domains to achieve different combinations, such as the predefined combinations described below.

In at least one embodiment, the energy saving logic 104 can use one of seven different predefined combinations of parameters, as set forth in the following Table 1:

| | AP/TRx | | |
|---|---|---|---|
| | turned | Beam | |
| Combination Identifier | on | Weights/bands | Beams |
| C0: Common 256 AP/TRx | all | 32 beam weights | 2 vertical |
| for upper and lower bands | AP/TRx | for each band/2 | beams(7.5°) × |
| (Max. power consumption) | turned | bands | 16 horizontal |
| | on | | beams(7.5°) |
| C1: Separate 128 AP/TRx | 128 | 16 beam weights | 2 vertical |
| for upper and lower bands | AP/TRx | for each band/2 | beams(15°) × |
| | turned | bands | 8 horizontal |
| | on | | beams(15°) |
| C2: Separate 64 AP/TRx | 64 | 8 beam weights | 8 horizontal |
| optimized with | AP/TRx | for each band/2 | beams(15°) |
| lower beams for upper | turned | bands | |
| and lower bands | on | | |
| C3: 128 AP/TRx only for | 128 | 16 beam weights | 2 vertical |
| the lower band | AP/TRx | for one band/1 | beams(15°) × |
| | turned | band | 8 horizontal |
| | on | | beams(15°) |
| C4: 64 AP/TRx optimized | 64 | 8 beam weights | 8 horizontal |
| with lower beams only for | AP/TRx | for one band/1 | beams(15°) |
| the lower band | turned | band | |
| | on | | |
| C5: 32 AP/TRx optimized | 32 | 4 beam weights | 4 horizontal |
| with limited beams only | AP/TRx | for each band/ 1 | beams(30°) |
| for the lower band | turned | band | |
| | on | | |
| C6: Turn off all the TRx | all | | |
| and bands (Min. power | AP/TRx | | |
| consumption) | turned | | |
| | off | | |

The different combinations of parameters are illustrated and described below with respect to FIG. 7B to FIG. 7H.

FIG. 7B illustrates a first combination 708 of parameters of the extreme mMIMO system 700 of FIG. 7A according to at least one embodiment. In the first combination 708, the 256 AP/TRx for both the upper and lower bands are turned on for a maximum power consumption mode. The first combination 708 can include 32 beam weights for each band with 2 vertical beams (7.5°) and 16 horizontal beams (7.5°).

FIG. 7C illustrates a third combination 712 of parameters of the extreme mMIMO system 700 of FIG. 7A according to at least one embodiment. In the third combination 712, separate 128 AP/TRx for both the upper and lower bands are turned on with 16 beam weights for each band with 2 vertical beams (15°) and 8 horizontal beams (15°).

FIG. 7D illustrates a fourth combination 714 of parameters of the extreme mMIMO system 700 of FIG. 7A according to at least one embodiment. In the fourth combination 714, separate 64 AP/TRx for both the upper and lower bands are turned on with 8 beam weights for each band with 8 horizontal beams (15°).

FIG. 7E illustrates a fifth combination 716 of parameters of the extreme mMIMO system 700 of FIG. 7A according to at least one embodiment. In the fifth combination 716, 128 AP/TRx for only the lower band are turned on with 16 beam weights for each band with 2 vertical beams (15°) and 8 horizontal beams (15°).

FIG. 7F illustrates a sixth combination 718 of parameters of the extreme mMIMO system 700 of FIG. 7A according to at least one embodiment. In the sixth combination 718, 64 AP/TRx only for the lower band with 8 beam weights and 8 horizontal beams (15°).

FIG. 7G illustrates a seventh combination 720 of parameters of the extreme mMIMO system 700 of FIG. 7A according to at least one embodiment. In the seventh combination 720, 32 AP/TRx optimized with limited beams only for the lower band with 4 beam weights for each band and 4 horizontal beams (30°).

FIG. 7H illustrates a second combination 710 of parameters of the extreme mMIMO system 700 of FIG. 7A according to at least one embodiment. In the second combination 710, all AP/TRx and frequency bands are turned off for a minimum power consumption mode.

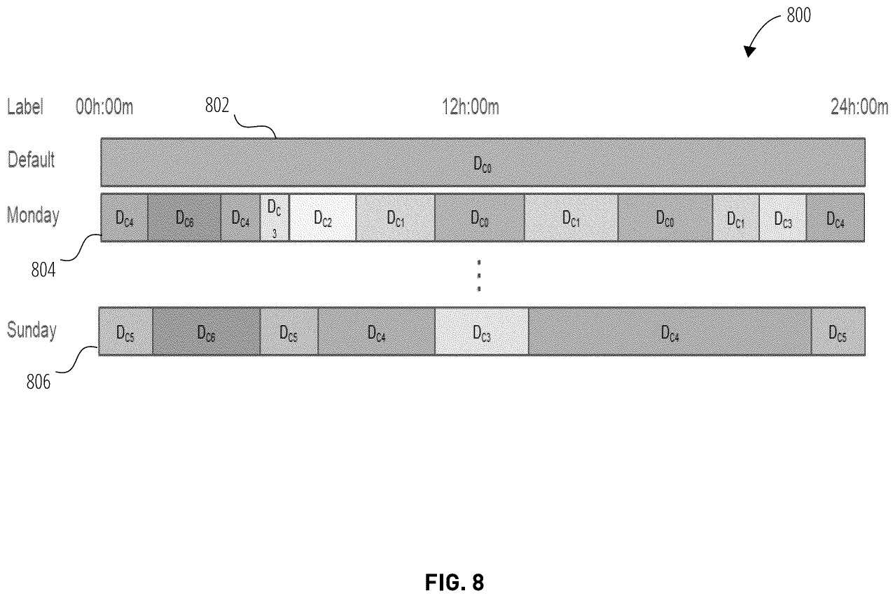

In addition to controlling the different parameters in the frequency (F) and space (S) domains to achieve different combinations, the energy saving logic 104 can control a schedule of durations of these different combinations in a time (T) domain, such as illustrated and described below with respect to FIG. 8.

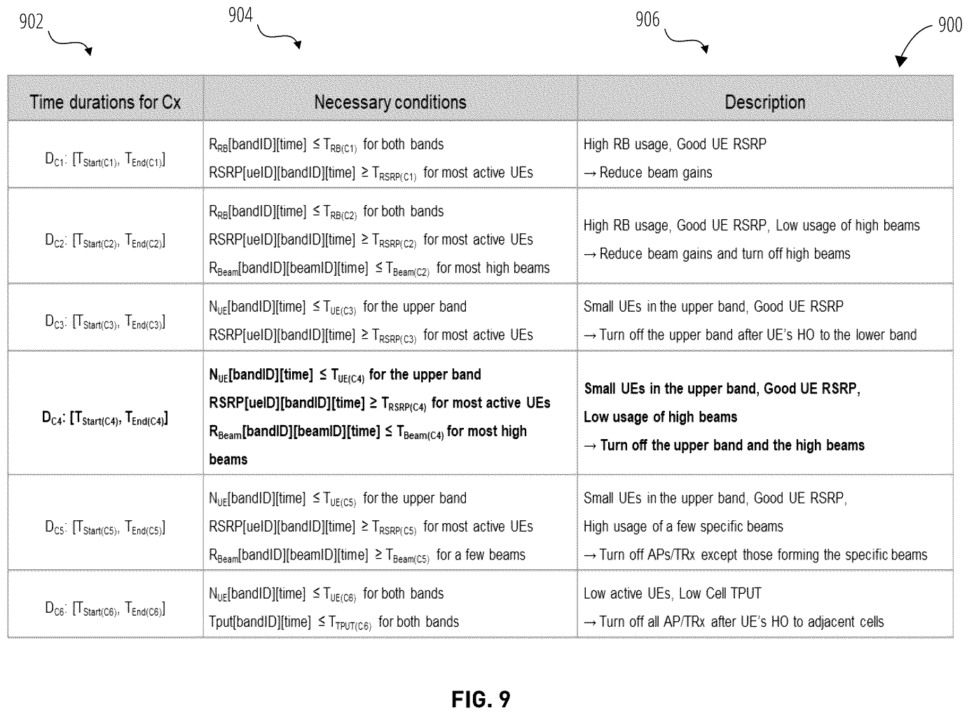

FIG. 8 illustrates an example ES mode schedule 800 of different durations of the combinations according to at least one embodiment. The ES mode schedule 800 includes a default mode 802 in which the first combination 708 is used for a specified duration. This default mode 802 can be overwritten with one or more additional schedules, such as first schedule 804 and second schedule 806. The first schedule 804 is for a first period of time, such as a day of the week (e.g., Monday). In the first schedule 804, the default mode 802 is overwritten with one of the ES modes, such as one of the predetermined combinations described above (e.g., combinations 710-720), for specified durations within the time period. The second schedule 806 is for a different period of time, such as another day of the week (e.g., Sunday). The second schedule 806 can have different ES modes for different durations within the time period. In other embodiments, the schedules can also be based on particular months, particular years, or other periods of time. The time durations of these ES modes can be set according to one or more rules or conditions, such as illustrated and described below with respect to FIG. 9.

FIG. 9 is an ES Saving table 900 with different time durations and the corresponding conditions according to at least one embodiment. The ES Saving table 900 includes different time durations 902 and corresponding necessary conditions 904. The ES Saving table 900 also includes a description of the corresponding entry. The time durations 902 can correspond to any of the combinations of parameters of the frequency (F) and space (S) domains described above (noted as Cx in ES Saving table 900). A first duration (D_{C1}) can include a start time and an end time. The necessary conditions 904 for the first duration (D_{C1}) can be used when a resource block (RB) needed is less than a threshold value (T_{RB(C1)}) for both bands and a Reference Signal Received Power (RSRP) value is greater than a threshold value (T_{RSRP(C1)}) for most active UEs. The corresponding description 906 can specify that the beam gains can be reduced when there is high RB usage and good UE RSRP. The other time durations 902 can have other necessary conditions 904 and description 906 for different scenarios, such as to reduce beam gains and turn off high beams, turn off the upper band after UE's handoff to the lower band, turn off the upper band and the high beams, turn off AP/TRx except those forming the specific beam, or turn off all AP/TRx after UE's handoff to adjacent cells. The necessary conditions 904 can also include parameters and corresponding thresholds for a number of beams (R_{Beam}), number of UEs in a band (N_{UE}), throughput (Tput), etc.

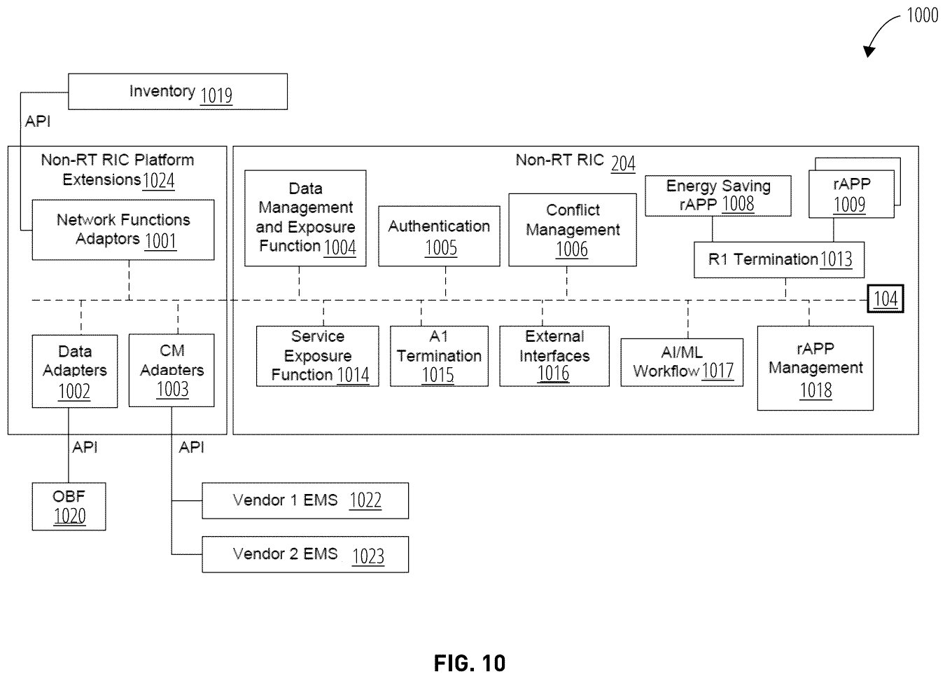

FIG. 10 shows an illustrative architecture 1000 of an example non-real-time RIC 204 with energy saving logic 104 according to at least one embodiment. As shown, architecture 1000 may include a non-real-time RIC 204 as described with respect to FIG. 2, which may interface with various vendors, such as vendor 1 vendor 1022 or vendor 2 1023, for various applications in the system 200. As shown in the architecture 1000, the Non-real-time RIC 204 may include one or more functions inside the RIC platform, such as a data management and exposure function 1004, an authentication function 1005, a conflict management function 1006, a service exposure function 1014, an A1 termination 1015, external interfaces 1016, artificial intelligence and/or machine learning AI/ML workflow 1017, rApplication (rAPP) management 1018, R1 termination 1013, data layer 1024, dedicated rAPP 1007, rAPP 1010, and/or energy saving logic 104.

As shown in FIG. 10, the vendors may interact with the non-real-time RIC 204 to request various network functions of the RIC platform. For example, in one implementation, vendor 1 1022 may be a commercial vendor and vendor 2 1023 may be a private vendor. Both vendor 1022 and vendor 1023 may be requesting to use network functions of the non-real-time RIC 204. When multiple vendors may request to use network functions of the non-real-time RIC 204, the non-real-time RIC 204 may interpret that as a request to create multi-tenant resources on the non-real-time RIC 204. In response to the request, the non-real-time RIC 204 may create the multi-tenant resources by assigning one or more controllers, such as a rAPP 1010 in the non-real-time RIC 204 example, as a dedicated network controller, or a dedicated rAPP 1007 as shown in the example of the non-real-time RIC 204. The dedicated controller, such as dedicated rAPP 1007 in the non-real-time RIC 204 example may be able to control vendor data and/or network functions for an associated vendor that the dedicated controller is responsible for. In some implementations, the dedicated rAPP 1008 may be assigned to manage the vendor data and/or network functions for vendor 1 1022 and the dedicated rAPP 1009 may be assigned to manage the vendor data and/or network functions for vendor 2 1023. By using the dedicated rAPPs 1007, a non-real-time RIC 204 may be able to provide commercial network services for a commercial vendor, such as vendor 1 1022 in the example in FIG. 10, while the non-real-time RIC 204 may also be able to provide private network functions for a private vendor, such as vendor 2 1023 and the non-real-time RIC 204 may be able share certain resources of the non-real-time RIC 204 to efficiently provide for multi-tenant service of both vendors on the same non-real-time RIC 204.

In some implementations, the dedicated rAPP 1007 may work with other dedicated resources within the non-real-time RIC 204 and only the dedicated rAPP 1007 has access to the other dedicated resources on the non-real-time RIC 204 in order to keep the vendor data and/or network functions private for each of the vendors in the multi-tenant RIC platform. For example, in some implementations, the dedicated rAPP 1007 may be the only component of the non-real-time RIC 204 that can access the private data associated with the vendor in the data layer 1024. In some implementations, different dedicated rAPPs 1007 may be generated or assigned for each vendor that is requesting to use the shared network resources in a multi-tenant network function. Each of the dedicated rAPPs 1007 are the only network resources able to access and manage stored vendor data, such as private data, or execute network functions on the non-real-time RIC 204. By separating the rAPP 1010 as a dedicated rAPP 1007 or other dedicated controller, the non-real-time RIC 204 is able to share various network resources while also allowing private vendor data to be separate. It should be understood that while two vendors 1022 and 1023 are shown in this example, any number of vendors 1021 may be using a multi-tenant RIC platform based on the available network resources to separate the multiple vendors and it is not just limited to two vendors 1022 and/or 234b as shown in the example in FIG. 10.

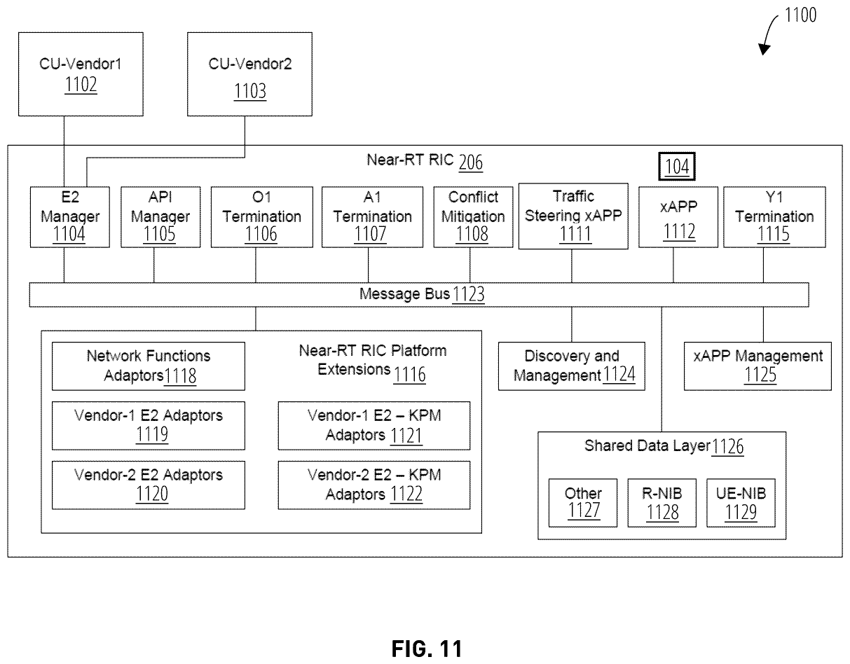

FIG. 11 shows an illustrative architecture 1100 of an example near-real-time RIC 206 with energy saving logic 104 according to at least one embodiment. As shown, architecture 1100 may include a near-real-time RIC 206 as described with respect to FIG. 2, which may interface with one or more vendors 1102, 1103 that may request various network functions of the near-real-time RIC 206 for various applications in the system 200. As shown in the architecture 1100, the near-real-time RIC 206 may include one or more functions inside the RIC platform, such as an E2 manager 1104, an API manager 1105, an O1 termination 1106, an A1 termination 1107, a conflict mitigation 1108, one or more dedicated xApplications (xAPPs) 1110, one or more xAPPs 1011, a Y1 termination, discovery and discovery and management 1124, xAPP management, a shared data layer 1126 including one or more of other 1127, R-NIB 1128, UE-NIB 1129, and/or private data, and/or energy saving logic 104. As shown in FIG. 11, the various components E2 manager 1104, application program interface (API) Manager 1105, O1 termination 1106, A1 termination 1107, and/or Y1 termination 1115 allow for data flow to and from the various data lines shown in system 200 in FIG. 2.

As shown in FIG. 11, the vendors 1101 may interact with the near-real-time RIC 206 to request various network functions of the RIC platform. For example, in one implementation, vendor1 1102 may be a commercial vendor and vendor2 1103 may be a private vendor. Both vendor 1102 and vendor 1103 may be requesting to use network functions of the near-real-time RIC 206. When multiple vendors may request to use network functions of the near-real-time RIC 206, the near-real-time RIC 206 may interpret that as a request to create multi-tenant resources on the near-real-time RIC 206. In response to the request, the near-real-time RIC 206 may create the multi-tenant resources by assigning one or more controllers, such as an xAPP 1113 in the near-real-time RIC 206 example, as a dedicated network controller, or a dedicated xAPP 1109 as shown in the example of the near-real-time RIC 206. The dedicated controller, such as dedicated xAPP 1109 in the Near-real-time RIC 206 example may be able to control vendor data and/or network functions for an associated vendor that the dedicated controller is responsible for. In some implementations, the dedicated xAPP 1111 may be assigned to manage the vendor data and/or network functions for vendor1 1102 and the dedicated xAPP 1112 may be assigned to manage the vendor data and/or network functions for vendor2 1103. By using the dedicated xAPPs 1109, a Near-real-time RIC 206 may be able to provide commercial network services for a commercial vendor, such as vendor1 1102 in the example in FIG. 11, while the near-real-time RIC 206 may also be able to provide private network functions for a private vendor, such as vendor2 1103 and the near-real-time RIC 206 may be able share certain resources of the near-real-time RIC 206 to efficiently provide for multi-tenant service of both vendors on the same near-real-time RIC 206.

In some implementations, the dedicated xAPP 1109 may work with other dedicated resources within the near-real-time RIC 206 and only the dedicated xAPP 1109 has access to the other dedicated resources on the near-real-time RIC 206 (e.g., no other xAPP 1113 has access to resources assigned and/or generated for a dedicated xAPP 1109) in order to keep the vendor data and/or network functions private for each of the vendors in the multi-tenant RIC platform. For example, in some implementations, the dedicated xAPP 1109 may be the only component of the near-real-time RIC 206 that can access the private data associated with the vendor1 1102 in the shared data layer 1126. In some implementations, different dedicated xAPPs 1109 may be generated or assigned for each vendor that requests to use the shared network resources in a multi-tenant network function. Each of the dedicated xAPPs 1109 are the only network resources able to access and manage stored vendor data, such as private data, or execute network functions on the near-real-time RIC 206. In some implementations, only the dedicated xAPP 1109 that is managing the private network for a specific vendor will be able to see any of the data, such as vendor data or vendor network functions, associated with that vendor. None of the other vendors 1101 of the multi-tenant RIC platform are able to access and/or view any data associated with other vendors 1101. By separating the xAPP 1113 as a dedicated xAPP 1109 or other dedicated controller, the near-real-time RIC 206 is able to share various network resources while also allowing private vendor data to be separate. It should be understood that while two vendors 1102 and 1103 are shown in this example, any number of vendors 1101 may be using a multi-tenant RIC platform based on the available network resources to separate the multiple vendors and it is not just limited to two vendors 1102 and/or 320b as shown in the example in FIG. 11.

As shown in FIG. 11, the near-real-time RIC 206 is delay sensitive, so delay sensitive communications, such as vendor data and/or vendor network requests come in through the E2 line and the E2 manager 1104. It should be understood that using the multi-tenant RIC platform with dedicated xAPPs 1109 that control access for network functions and/or private data associated with different vendors 1101 are still able to perform these actions in a delay sensitive manner. The E2 manager 1104 is simple directing specific vendor requests to specific dedicated xAPPs 1109 to service specific vendors 1101 associated with those dedicated xAPPs 1109 while the other available near-real-time RIC 206 resources are shared between the different vendors 1101 in the multi-tenant RIC platform as appropriate. As shown in FIG. 11, while vendor data will still come in through the E2 manager 1104, that vendor data is isolated by the dedicated controller, such as the dedicated xAPP 1109 so that no other applications of the RIC platform will see that the vendor specific RAN functions are connected to the platform. This allows multiple vendors 1101 to receive various network function support using the RIC platforms without needing to generate and run separate RIC platforms for each of the vendors. Instead, a dedicated controller, such as a dedicated xAPP 1109 or dedicated rAPP 1007 based on the RIC platform, manages the vendor data for each of the vendors on the same RIC platform to provide for a more efficient use of the RIC platform and network resources.

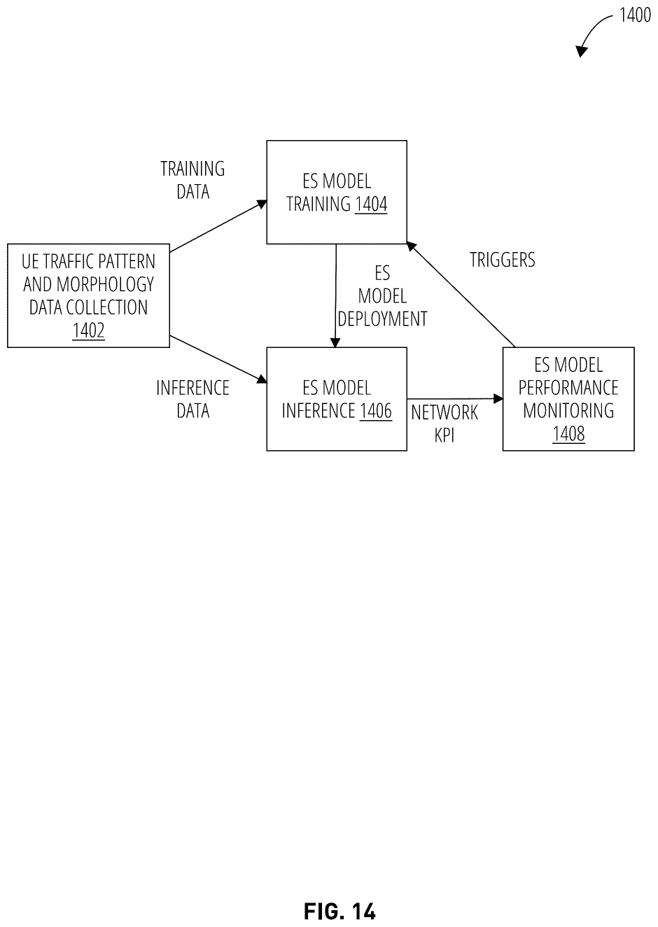

As described herein, the energy saving logic 104 can collect data and determine an energy saving mode based on the collected data. The energy saving logic 104 can use thresholds, algorithms, ranges, or the like to determine energy saving modes based on the collected data. In at least one embodiment, the energy savings logic can use artificial intelligence AI/ML models for predicting energy saving modes for an mMIMO system or an extreme mMIMO system in a cellular network, such as illustrated in FIG. 14.

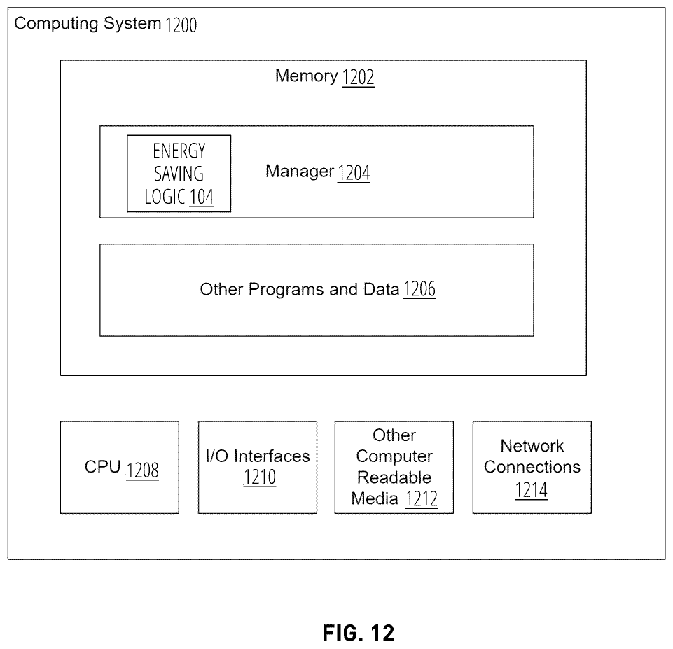

FIG. 12 shows a system diagram that illustrates an example computing system 1200 that implements and/or comprises one or more components of a system that implements energy saving logic 104 on a RIC platform as described herein. In various embodiments, the computing system 1200 can be implemented either as network elements on dedicated hardware, as a software instance running on dedicated hardware, or as a virtualized function instantiated on an appropriate platform, e.g., a cloud infrastructure. In some embodiments, many operations and functionality of such systems may be completely software-based and designed as cloud-native, meaning that they are agnostic to the underlying cloud infrastructure, allowing higher deployment agility and flexibility. Accordingly, various embodiments described herein may be implemented in software, hardware, firmware, or in some combination thereof. Computing system 1200 may include memory 1202, one or more central processing units (CPUs) 1208, I/O interfaces 1406, other computer-readable media 1007, and network connections 1408.

Memory 1202 may include one or more various types of non-volatile and/or volatile storage technologies. Examples of memory 1202 may include, but are not limited to, flash memory, hard disk drives, optical drives, solid-state drives, various types of random access memory (RAM), various types of read-only memory (ROM), other computer-readable storage media (also referred to as processor-readable storage media), non-transitory computer-readable medium, or the like, or any combination thereof. Memory 1202 may be utilized to store information, including computer-readable instructions that are utilized by CPU 1208 to perform actions, including embodiments described herein.

Memory 1202 may have stored thereon access manager 1204. The manager 1204 is configured to implement and/or perform various control functions to implement operations of the network applications, including the energy saving logic 104, on a RIC platform described herein, such as with one or more processors. Memory 1202 may also store other programs and input data 1206, which may include control systems for functionality for the cellular wireless telecommunication network, control systems for amplifying, digitizing, transmitting and receiving RF signals associated with radio towers for the cellular wireless telecommunication network, performance statistics, network interference management and statistics, quality of service management and statistics, throughput statistics, databases, user interfaces, operating systems, other network management functions, other NFs, etc.

Network connections 1214 are configured to communicate with other computing devices, telecommunication equipment, computer network equipment and/or radio antennas, to perform operations of the computing system 1200. In various embodiments, the network connections 1214 may include transmitters and receivers to send and receive data as described herein; hardware that implements functionality of the multi-tenant network applications on a RIC platform for the cellular wireless telecommunication network; hardware that implements systems for amplifying, digitizing, transmitting and receiving the RF signals associated with radio towers for the cellular wireless telecommunication network; radio hardware including one or more amplifiers, filters, analog-to-digital (A/D) converters, wiring, antennas and base-station towers and/or interfaces thereto; etc.

I/O interfaces 1210 may include video interfaces, other data input or output interfaces, or the like. In some embodiments, I/O interfaces 1210 may include transmitters and receivers to send and receive data as described herein; hardware that implements systems for functionality of the multi-tenant network applications on a RIC platform for the cellular wireless telecommunication network; hardware that implements systems for amplifying, digitizing, transmitting and receiving the RF signals associated with radio towers for the cellular wireless telecommunication network; radio hardware including one or more amplifiers, filters, analog-to-digital (A/D) converters, wiring, antennas and base-station towers and/or interfaces thereto; etc.

Other computer readable media 1212 may include other types of stationery or removable computer-readable media, such as removable flash drives, external hard drives, or the like.

In some embodiments, one or more special-purpose computing systems may be used to implement systems of the manager 1204. Accordingly, various embodiments described herein may be implemented in software, hardware, firmware, or in some combination thereof.

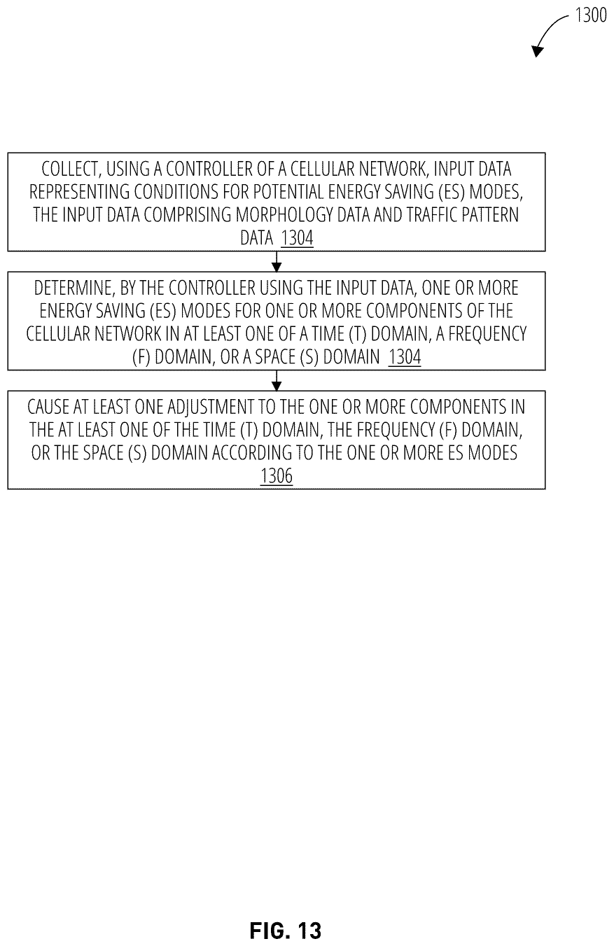

FIG. 13 is a flow diagram of a method 1300 for energy saving operations according to at least one embodiment. The method 1300 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 1300 is performed by the RAN controller 102 of FIG. 1A. In at least one embodiment, the method 1300 is performed by energy saving logic 104 of FIG. 1A. In at least one embodiment, the method 1300 is performed by the DU 127, CU 129, network core 139, or orchestrator 138 of FIG. 1A. In at least one embodiment, the method 1300 is performed by the energy saving logic 104 of non-real-time RIC 204 or the energy saving logic 104 of near-real-time RIC 206 of FIG. 2. In another embodiment, the method 1300 is performed by a base station or a network core of a cellular network.

Referring to FIG. 13, the method 1300 begins with the processing logic collecting data representing conditions for potential energy saving (ES) modes, comprising morphology data and traffic pattern data (block 1302). At block 1304, the processing logic determines, using the collected data, one or more energy saving (ES) modes for one or more components of a cellular network in at least one of a time (T) domain, a frequency (F) domain, or a space (S) domain. The processing logic causes at least one adjustment to the one or more components in the at least one of the time (T) domain, the frequency (F) domain, or the space (S) domain according to the one or more ES modes.

wherein the morphology data and traffic pattern data comprises at least one of a traffic load of user equipment (UE) traffic data, a UE signal-to-noise (SNR), a UE Receive Signal Strength Indicator (RSSI), a UE Channel State Information (CSI), a number of UEs, a resource block (RB) usage rate, a type of traffic, or morphology information.

In at least one embodiment, the one or more components includes an RU with an extreme mMIMO system that supports at least two adjacent frequency bands. The extreme mMIMO system can include a plurality of antenna ports and corresponding amplifiers and transceivers configurable to be turned on or off and weight sets being configurable to adjust a number of beams and a beam width of the number of beams. To make the one or more adjustments, the processing logic can configure a first number of the plurality of antenna ports and corresponding amplifiers and transceivers to be turned on or off in a first ES mode, configure a first number of beams in the first ES mode, and configure a first beam width of the number of beams in the first ES mode.

In at least one embodiment, the one or more ES modes includes a set of predefined combinations of parameters in the space (S) domain and parameters in the frequency (F) domain. The set of predefined combinations can include: i) a first combination comprising a first number of antenna ports and corresponding amplifiers and transceivers turned on for an upper frequency band and a lower frequency band, the first combination corresponding to a maximum power consumption mode; ii) a second combination comprising the first number of antenna ports and corresponding amplifiers and transceivers turned off for the upper frequency band and the lower frequency band, the second combination corresponding to a minimum power consumption mode of the one or more ES modes; and iii) one or more additional combinations comprising different number of antenna ports and corresponding amplifiers and transceivers turned on for at least one of the upper frequency band or the lower frequency band, the one or more additional combinations corresponding to others of the one or more ES modes.

In at least one embodiment, the first number can be 256 antenna ports and corresponding amplifiers and transceivers. The first combination can include the 256 antenna ports and corresponding amplifiers and transceivers turned on for the upper frequency band and the lower frequency band, 32 beam weights for each of the upper frequency band and the lower frequency band, two vertical beams with a beam width of 7.5 degrees, and sixteen horizontal beams with the beam width of 7.5 degrees. The second combination can include the 256 antenna ports and corresponding amplifiers and transceivers turned off for the upper frequency band and the lower frequency band. A third combination can include 128 antenna ports and corresponding amplifiers and transceivers turned on for the upper frequency band and the lower frequency band, 16 beam weights for each of the upper frequency band and the lower frequency band, two vertical beams with a beam width of 15 degrees, and eight horizontal beams with the beam width of 15 degrees. A fourth combination can include 64 antenna ports and corresponding amplifiers and transceivers turned on and optimized with lower beams for the upper frequency band and the lower frequency band, 8 beam weights for each of the upper frequency band and the lower frequency band, and eight horizontal beams with the beam width of 15 degrees. A fifth combination can include 128 antenna ports and corresponding amplifiers and transceivers turned on for only the lower frequency band, 16 beam weights for the lower frequency band, two vertical beams with the beam width of 15 degrees, and eight horizontal beams with the beam width of 15 degrees. A sixth combination can include 64 antenna ports and corresponding amplifiers and transceivers turned on for only the lower frequency band, 8 beam weights for the lower frequency band, and eight horizontal beams with the beam width of 15 degrees. A seventh combination can include 32 antenna ports and corresponding amplifiers and transceivers turned on and optimized with limited beams for only the lower frequency band, 4 beam weights for the lower frequency band, and four horizontal beams with the beam width of 30 degrees.

As described herein, the processing logic can be implemented in a controller. The controller can be a non-real-time RIC or a near-real-time RIC. In another embodiment, the controller can be implemented in both the non-real-time RIC and the near-real-time RIC. In other embodiments, the controller can be part of an Element Management System (EMS). The EMS system can be part of a cloud computing system or a dedicated system.

FIG. 14 is a flow diagram of a method 1400 of training energy saving (ES) models and using trained ES models for interference according to at least one embodiment. The method 1400 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 1400 is performed by the RAN controller 102 of FIG. 1A. In at least one embodiment, the method 1400 is performed by energy saving logic 104 of FIG. 1A. In at least one embodiment, the method 1400 is performed by the DU 127, CU 129, network core 139, or orchestrator 138 of FIG. 1A. In at least one embodiment, the method 1400 is performed by the energy saving logic 104 of non-real-time RIC 204 or the energy saving logic 104 of near-real-time RIC 206 of FIG. 2. In another embodiment, some or all operations of the method 1400 are performed by a base station or a network core of a cellular network.

Referring to FIG. 14, the method 1400 begins with the processing logic collecting UE traffic pattern data and morphology data, as described herein (block 1402). The collected data can be used as training data for ES model training at block 1404. At block 1404, the processing logic trains an ES model that predicts one or more energy savings modes for one or more components or functions of a cellular network. Once trained, the processing logic can deploy the trained ES model for inference at block 1406. At block 1406, the processing logic can receive inference data. The inference data can include UE traffic pattern data and morphology data, as described herein. The ES model at block 1406 can determine one or more energy saving modes. At block 1406, the processing logic can also output network key performance indicators (KPIs) for performance monitoring at block 1408. At block 1408, the processing logic performs ES model performance monitoring. The ES performance can be an amount of energy savings. One or more triggers can be defined that cause the processing logic to redo training or fine-tune the training at block 1404.

In at least one embodiment, the AI/ML ES model can be trained with input data and output data, where the input data can be the UE traffic data and morphology information, and the output data can be network key performance indicator(s) (KPI(s)) (also referred to as monitored data) and energy saving efficiency. The AI/ML ES model can be trained for ES domains (T, F, and S) and ES modes. The AI/ML ES model can be deployed for ES model inference at block 1406. Inference data, including UE traffic pattern and morphology data, can be collected and input into the trained AI/ML ES model for ES model inference. The ES model inference can cause one or more actions to be performed to achieve energy savings in one or more of the ES domains (T, F, and S). In addition, the ES model inference can output network KPIs for ES model performance modeling, which can feedback into the ES model training, in response to one or more triggers. In other embodiments, other predictive equations or models can be used to determine energy savings modes based on the collected data.

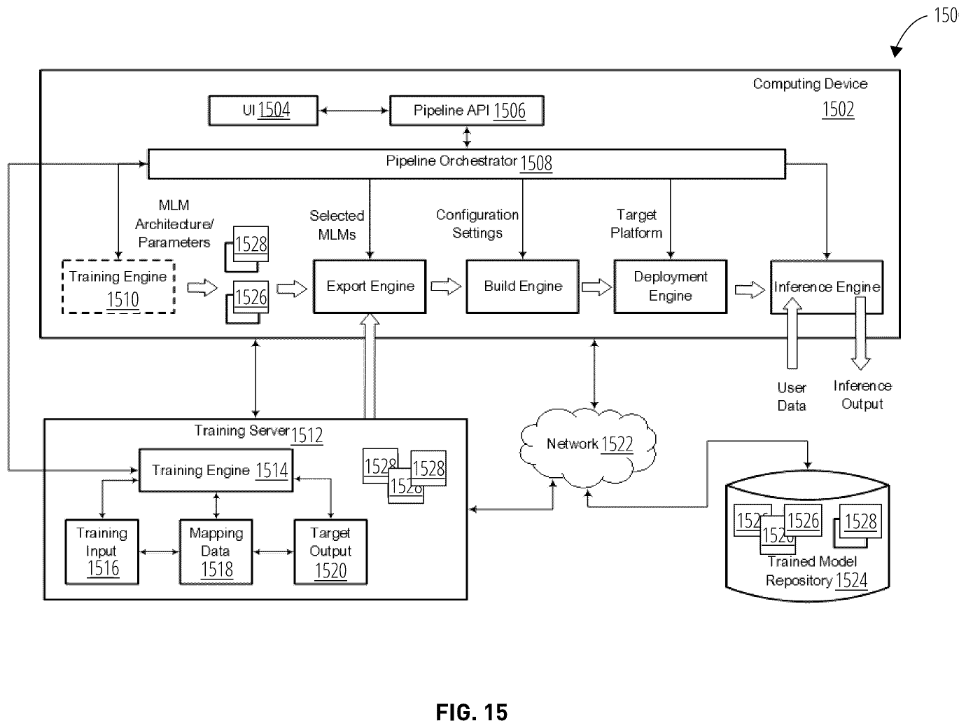

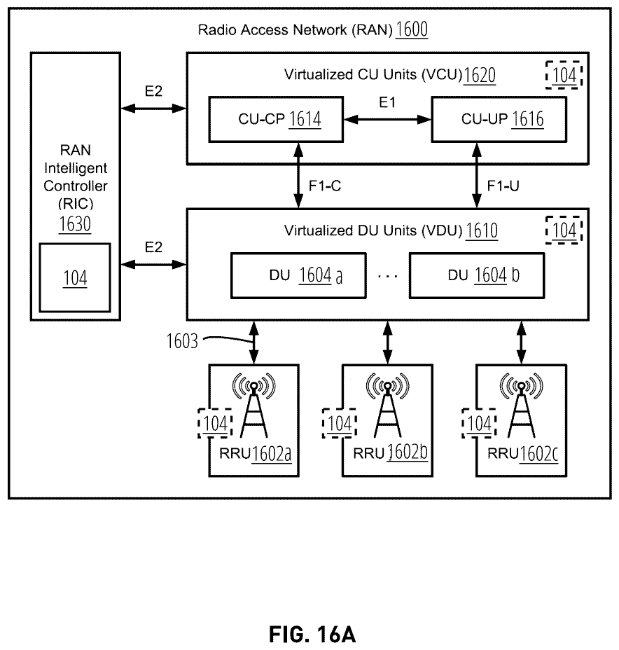

FIG. 15 is a block diagram of an example architecture of customizable pipeline (CP) 1500 that supports training, configuring, and deploying of one or more machine learning models, in accordance with at least some embodiments. As depicted in FIG. 2, a CP 1500 may be implemented on a computing device 1502, but it should be understood that any engines and components of computing device 1502 may be implemented on (or shared among) any number of computing devices or on a cloud. Computing device 1502 may be a desktop computer, a laptop computer, a smartphone, a tablet computer, a server, a computing device that accesses a remote server, a computing device that utilizes a virtualized computing environment, a gaming console, a wearable computer, a smart TV, and so on. A user of CP 1500 may have a local or remote (e.g., over a network 1522) access to computing device 1502. Computing device 1502 may have any number of central processing units (CPUs) and graphical processing units (GPUs), including virtual CPUs and/or virtual GPUs, or any other suitable processing devices capable of performing the techniques described herein. Computing device 1502 may further have any number of memory devices, network controllers, peripheral devices, and the like. Peripheral devices may include cameras (e.g., video cameras) for capturing images (or sequences of images), microphones for capturing sounds, scanners, sensors, or any other devices for data intake.

In some embodiments, a CP 1500 may include a number of engines and components for efficient machine learning model (MLM) implementation. A user (customer, end user, developer, data scientist, etc.) may interact with CP 1500 via a user interface UI 1504, which may include a command line, a graphical UI, a web-based interface (e.g., a web-browser accessible interface), a mobile application-based UI, or any combination thereof. UI 1504 may display menus, tables, graphs, flowcharts, graphical and/or textual representations of software, data, and workflows. UI 1504 may include selectable items, which may enable the user to enter various pipeline settings, provide training/retraining and other data, as described in more detail below. User actions entered via UI 1504 may be communicated to a pipeline orchestrator 1508 of CP 1500 via a pipeline API 1506. In some embodiments, prior to receiving pipeline data from pipeline orchestrator 1508, the user (or the remote computing device that the user is using to access the pipeline) may download an API package to the remote computing device. The downloaded API package may be used to install pipeline API 1506 on the remote computing device to enable the user to have a two-way communication with pipeline orchestrator 1508 during setting up and using CP 1500.

Pipeline orchestrator 1508, via pipeline API 1506, may provide the user with various data that may be used in configuring and deploying one or more MLMs and using the deployed MLMs for processing (inferencing) of various input user data. For example, pipeline orchestrator 1508 may provide the user with information about available pre-trained MLMs, may enable retraining of pre-trained MLMs on user-specific data provided by the user or training of new (previously untrained) MLMs. Pipeline orchestrator 1508 may then build CP 1500 based on the information received from the user. For example, pipeline orchestrator 1508 may configure user-selected MLMs and deploy the selected MLMs together with various other (e.g., pre- and post-processing) stages that are used in implementing the selected MLMs. To perform these and other tasks, pipeline orchestrator 1508 may coordinate and manage a number of engines, each engine implementing a part of the overall pipeline functionality.

In some embodiments, CP 1500 may have access to one or more previously trained (pre-trained) MLMs and may, therefore, provide the user with access to at least some (e.g., based on the user's subscription) of these pre-trained MLMs. The MLMs may be trained for common tasks in the area of the CP specialization. For example, a CP that is specialized in speech processing may have access to one or more MLMs trained to recognize some typical speech, such as customer service requests, common conversations, and the like. CP 1500 may further include a training engine 1510. Training engine 1510 may implement retraining (additional training) of the pre-trained MLMs. Retraining may be performed using retraining data tailored for a user-specific domain of use. In some embodiments, the retraining data may be provided by the user. For example, a user may provide retraining data to enhance natural language processing capabilities of one of the pre-trained MLMs to improve recognition of speech that may be encountered in an investment brokerage environment or a securities trading environment. The data may be provided (e.g., by a technology specialist at the user's financial company) in the form of audio digital recordings in any available (compressed or uncompressed) digital format, e.g., WAV, WavPack, WMA, MP3, MPEG, as a sound track of a video recording, a TV program, and the like.

Pre-trained MLMs 1526 may be stored in a trained model repository 1524, which may be accessible to computing device 1502 over a network 1522. Pre-trained MLMs 1526 may be trained by a training server 1512. Network 1522 may be a public network (e.g., the Internet), a private network (e.g., a local area network (LAN), or wide area network (WAN)), a wireless network, a personal area network (PAN), or a combination thereof. In some embodiments, training server 1512 may be a part of computing device 1502. In other embodiments, training server 1512 may be communicatively coupled to computing device 1502 directly or via network 1522. Training server 1512 may be (and/or include) a rackmount server, a router computer, a personal computer, a laptop computer, a tablet computer, a desktop computer, a media center, or any combination thereof. Training server 1512 may include a training engine 1514. The training engine 1514 on training server 1512 may be the same as (or similar to) training engine 1510 on computing device 1502. In some embodiments, training engine 1510 on computing device 1502 may be absent; instead, all training and retraining may be performed by training engine 1514 on training server 1512. In some embodiments, training engine 1514 may perform off-site training of pre-trained MLMs 1526 whereas training engine 1510 on computing device 1502 may perform retraining of pre-trained MLMs 1526 as well as training of new (custom) MLMs 1528.

During training or retraining, training engine 1514 (or 1510) may generate and configure one or more MLMs 1528. MLMs 1528 may include regression algorithms, decision trees, support vector machines, K-means clustering models, neural networks, or any other machine learning algorithms. Neural network MLMs may include convolutional, recurrent, fully connected, Long Short Term Memory models, Hopfield, Boltzmann, or any other types of neural networks. Generating MLMs may include setting up an MLM type (e.g., a neural network), architecture, a number of layers of neurons, types of connections between the layers (e.g., fully connected, convolutional, deconvolutional, etc.), the number of nodes within each layer, types of activation functions used in various layers/nodes of the network, types of loss functions used in training of the network, and so on. Generating MLMs may include setting (e.g., randomly) initial parameters (weights, biases) of various nodes of the networks. The generated MLMs 1528 may be trained by training engine 1514 using training data that may include training input(s) 1516 and corresponding target output(s) 1520. Additionally, training engine 1514 may generate mapping data 1518 (e.g., metadata) that associates training input(s) 1516 with correct target output(s) 1520. During training of MLMs 1528 (or pre-trained MLMs 1526), training engine 1514 (or 1510) may identify patterns in training input(s) 1516 based on desired target output(s) 1520 and train the respective MLMs to perform desired tasks. Predictive utility of the identified patterns may subsequently be verified using additional training input/target output associations before being used, during inference stage, in future processing of new speeches. In some embodiments, multiple MLMs may be trained, simultaneously or separately.

In some embodiments, each or some of MLMs 1528 (and/or MLMs 1526) may be implemented as deep learning neural networks having multiple levels of linear or non-linear operations. For example, MLMs 1528 may be convolutional neural networks, recurrent neural networks (RNN), fully connected neural networks, and so on. In some embodiments, each or some of MLMs 1528 (and/or pre-trained MLMs 1526) may include multiple neurons wherein each neuron may receive its input from other neurons or from an external source and may produce an output by applying an activation function to the sum of (trainable) weighted inputs and a bias value. In some embodiments, each or some of MLMs 1528 (and/or pre-trained MLMs 1526) may include multiple neurons arranged in layers, including an input layer, one or more hidden layers, and an output layer. Neurons from adjacent layers may be connected by weighted edges. Initially, edge weights may be assigned some starting (e.g., random) values. For every training input 1516, training engine 1514 may cause each or some of MLMs 1528 (and/or pre-trained MLMs 1526) to generate target output 1520. Training engine 1514 may then compare observed output(s) with the desired target output 1520. The resulting error or mismatch, e.g., the difference between the desired target output 1520 and the actual output(s) of the neural networks, may be back-propagated through the respective neural networks, and the weights in the neural networks may be adjusted to make the actual outputs closer to the target outputs 1520. This adjustment may be repeated until the output error for a given training input 1516 satisfies a predetermined condition (e.g., falls below a predetermined value). Subsequently, a different training input 1516 may be selected, a new output generated, and a new series of adjustments implemented, until the respective neural networks are trained to an acceptable degree of accuracy.

Training engine 1514 may include additional (compared with training engine 1510) components to implement retraining of previously trained MLMs 1526 for domain-specific applications. For example, training engine 1514 may include a data augmentation module, to augment existing training data (e.g., training input 1516) with domain-specific data. Target outputs 1520 may similarly be augmented. For example, the data augmentation module may update target outputs 1520 with various terms of art, such as “options,” “futures,” that have domain-specific meaning. Training engine 1514 may additionally have a pruning module to reduce the number of nodes and an evaluation module to determine whether the pruning of nodes has not reduced the accuracy of the retrained model below a minimum threshold accuracy.

In some aspects, one or more components of the CP 1500 may be used for training a machine learning model. For example, one or more components of the CP 1500, such as the training engine 1514 and the training server 1512 (among other examples), may be used for training the machine learning component operating on a computing device of the core network. Additional details regarding training the machine learning model are described below.

A machine learning component monitoring network traffic can adjust network parameters for energy saving modes. The machine learning component may be executed on the core network, or may otherwise communicate with the core network, to monitor and analyze network traffic. For example, the machine learning component may be executed by a computing device hosted by a centralized node associated with the core network. The core network node may adjust one or more network parameters based on an output of the machine learning component. The machine learning component may predict potential energy saving modes and may adjust timers and thresholds proactively. In some aspects, the machine learning component may analyze historical network data, traffic patterns, packet loss rates, latency trends, and/or performance metrics, among other examples. By training the machine learning model on this data, the machine learning model can learn to recognize patterns indicative of potential energy saving opportunities.

In some aspects, the machine learning model 170 can be used to optimize network resource allocation for energy savings based on predicted traffic patterns and user demand. This proactive approach ensures scalability and reduces performance degradation before they impact user experience. In some aspects, the machine learning model can continuously learn from real-time network data to refine predictions and optimize strategies over time. This adaptive learning process enables the wireless communication network to stay responsive to evolving conditions and challenges.

In at least one embodiment, the core network (and/or the machine learning component) may perform data collection and pre-processing. The core network may gather relevant data from various nodes or components of the cellular network, including traffic data, performance metrics, error logs, and historical patterns, among other examples. This data may be preprocessed to clean, normalize, and/or prepare the data for analysis by the machine learning model. The core network and/or the machine learning model may perform ES mode identification to identify and extract, from the pre-processed data, features that are indicative of network behavior and performance. Once the machine learning model is trained and validated, the machine learning model may be deployed in the network environment and may continuously monitor incoming network data (in real time). When the machine learning model identifies patterns or deviations that match predefined criteria, the machine learning model can generate predictions for energy saving opportunities. Based on the predictions made by the machine learning model, automated decision-making processes can be triggered within the network. These decisions can include adjusting aspects in the T, F, and S domains as described herein.

The machine learning model may be evaluated (continuously) against actual network outcomes. Feedback data, including the effectiveness of model-driven actions and any discrepancies between predicted and observed behavior, can be used to improve the machine learning model over time. Through continuous monitoring, learning, and adaptation, the machine learning model can become more accurate and effective in predicting energy saving opportunities, for example, by adapting to changes in network conditions, user behavior, and ensuring proactive and responsive network management.

In supervised learning scenarios, the data may be labeled to define the output that the model is to predict. The labeled data can be split into training set(s) and validation set(s). A training set can be used to train the machine learning model, while a validation set can be used to evaluate the performance of the machine learning model. The training process may include ingesting the labeled training data into the selected machine learning model. The machine learning model can learn from the input features and their corresponding labels to make predictions about the network. Additionally, a performance of the trained machine learning model performance can be evaluated using the validation set.

In at least one embodiment, the machine learning component may can monitor network traffic and can generate an output based on monitoring the network traffic. Once the training of the machine learning model using the validation set is complete, the machine learning model can be deployed for real-time predictions and monitoring in the network environment. The deployed machine learning model can be continuously monitored, and predictions by the machine leaning model can be compared against actual network outcomes. Feedback data from network and performance metrics can be used for ongoing model maintenance, retraining, and refinement to ensure its effectiveness in predicting and handling network issues.

The output of the machine learning model can be used for predicting potential energy saving opportunities and may be integrated into the network management. The output of the machine learning model, which may include predictions about potential energy saving opportunities, can trigger automated alerts and notifications. These alerts can be sent to network teams to inform them about energy saving opportunities in the network. Additionally, or alternatively, the output of the machine learning model can be visualized on dashboards and monitoring systems. Predictions, trends, and recommended actions that are based on the machine learning model analysis can be displayed on a user interface.

The output of the machine learning model can directly influence automated actions within the network. For example, if the machine learning model predicts energy saving modes on a particular path, the machine learning model may trigger automatic adjustments to aspects of the particular path. By analyzing the output of the machine learning model, network performance and resource utilization can be optimized. For example, the machine learning model recommendations may enhance load balancing strategies or traffic rerouting to improve overall network efficiency.

The output of the machine learning model can feed into a real-time monitoring and adjustment system that continuously evaluates network conditions and updates parameters accordingly. This monitoring and adjustment system can improve a likelihood of immediate response to detected anomalies or predicted network issues to prevent service degradation, adaptive resource allocation to maintain optimal performance and user experience in dynamic network environments, and continuous optimization based on feedback loops, performance metrics, and ML-driven insights, among other examples.

As described herein, integrating statistical values, real-time updates, and ML-driven recommendations into network management can enable dynamic resource allocation, parameter adjustments, and proactive responses to potential energy saving opportunities. This can improve resource utilization, enhance network efficiency, and maintain high-quality service delivery for users.

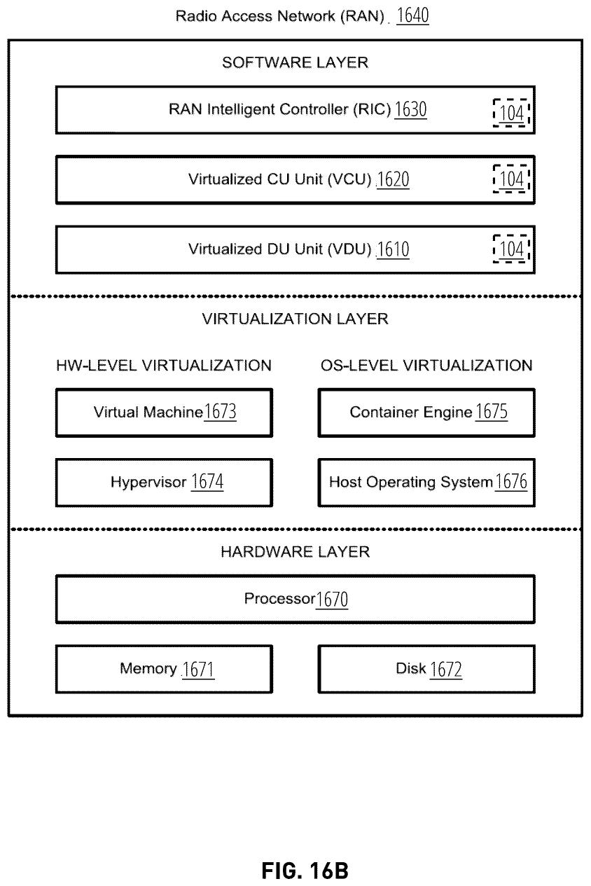

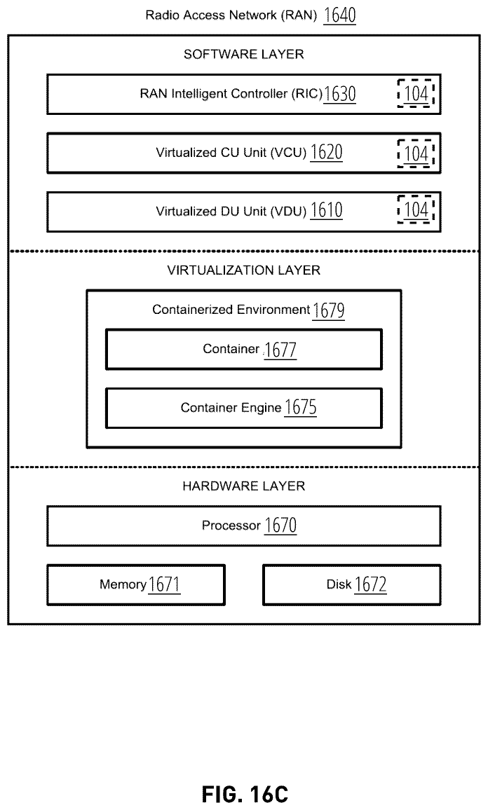

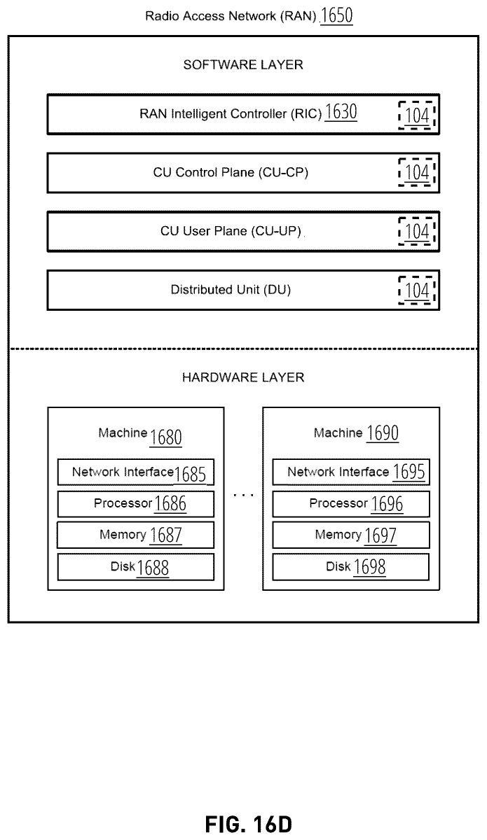

FIG. 16A depicts a RAN 1600 according to at least one embodiment. The RAN 1600 includes virtualized CU units (VCU) 1620, virtualized DU units (VDU) 1610, remote radio units (RRUs) 1602a-1602c, and a RAN intelligent controller (RIC) 1630. In at least one embodiment, the energy saving logic 104 can be implemented in the RIC 1630 to perform the energy saving operations described herein. The virtualized DU units 1610 can include virtualized versions of distributed units (DUs) 1604. The Distributed Unit (DU) 1604 can include a logical node configured to provide functions for the radio link control (RLC) layer, the medium access control (MAC) layer, and the physical layer (PHY) layers. The virtualized CU units 1620 can include virtualized versions of centralized units (CUs) including a centralized unit for the user plane CU-UP 1616 and a centralized unit for the control plane CU-CP 1614. In one example, the centralized units (CUs) can include a logical node configured to provide functions for the radio resource control (RRC) layer, the packet data convergence control (PDCP) layer, and the service data adaptation protocol (SDAP) layer. The centralized unit for the control plane CU-CP 1614 can include a logical node configured to provide functions of the control plane part of the RRC and PDCP. The centralized unit for the user plane CU-UP 1616 can include a logical node configured to provide functions of the user plane part of the SDAP and PDCP. Virtualizing the control plane and user plane functions allows the centralized units (CUs) to be consolidated in one or more data centers on RAN-based open interfaces.

The remote radio units (RRUs) 1602a-1602c may correspond with different cell sites. A single DU may connect to multiple RRUs via a fronthaul interface 203. In at least one embodiment, the energy saving logic 104 can be implemented in the individual RRUs 1602a-1602c to perform the energy saving operations described herein. The fronthaul interface 203 may provide connectivity between DUs and RRUs. For example, DU 1204a may connect to 18 RRUs via the fronthaul interface 1603. A centralized units (CUs) may control the operation of multiple DUs via a midhaul F1 Interface that includes the F1-C and F1-U interfaces. The F1 Interface may support control plane and user plane separation, and separate the Radio Network Layer and the Transport Network Layer. In one example, the centralized unit for the control plane CU-CP 1614 may connect to ten different DUs within the virtualized DU units 1610. In this case, the centralized unit for the control plane CU-CP 1614 may control ten DUs and 180 RRUs. A single Distributed Unit (DU) 1604 may be located at a cell site or in a local data center. Centralizing the Distributed Unit (DU) 1604 at a local data center or at a single cell site location instead of distributing the DU 1604 across multiple cell sites may result in reduced implementation costs.

The centralized unit for the control plane CU-CP 1614 may host the radio resource control (RRC) layer and the control plane part of the packet data convergence control (PDCP) layer. The E1 Interface may separate the Radio Network Layer and the Transport Network Layer. The CU-CP 1614 terminates the E1 Interface connected with the centralized unit for the user plane CU-UP 1616 and the F1-C interface connected with the distributed units (DUs) 1604. The centralized unit for the user plane CU-UP 1616 hosts the user plane part of the packet data convergence control (PDCP) layer and the service data adaptation protocol (SDAP) layer. The CU-UP 1616 terminates the E1 Interface connected with the centralized unit for the control plane CU-CP 1614 and the F1-U interface connected with the distributed units (DUs) DU 1604. The distributed units (DUs) 1604 may handle the lower layers of the baseband processing up through the packet data convergence control (PDCP) layer of the protocol stack. The interfaces F1-C and E1 may carry signaling information for setting up, modifying, relocating, and/or releasing a UE context.

The RAN intelligent controller (RIC) 1630 may control the underlying RAN elements via the E2 Interface. The E2 Interface connects the RAN intelligent controller (RIC) 1630 to the distributed units (DUs) 1604 and the centralized units CU-CP 1614 and CU-UP 1616. The RAN intelligent controller (RIC) 1630 can include a near-real time RIC. A non-real-time RIC (NRT-RIC) not depicted can include a logical node allowing non-real time control rather than near-real-time control and the near-real-time RIC 1630 can include a logical node allowing near-real-time control and optimization of RAN elements and resources on the bases of information collected from the distributed units (DUs) 1604 and the centralized units CU-CP 1614 and CU-UP 1616 via the E2 Interface.

The virtualization of the distributed units (DUs) 1604 and the centralized units CU-CP 1614 and CU-UP 1616 allows various deployment options that may be adjusted over time based on network conditions and network slice requirements. In at least one example, both a Distributed Unit (DU) 1604 and a corresponding centralized unit CU-UP 1616 may be implemented at a cell site. In another example, a Distributed Unit (DU) 1604 may be implemented at a cell site and the corresponding centralized unit CU-UP 1616 may be implemented at a local data center (LDC). In another example, both a Distributed Unit (DU) 1604 and a corresponding centralized unit CU-UP 1616 may be implemented at a local data center (LDC). In another example, both a Distributed Unit (DU) 1604 and a corresponding centralized unit CU-UP 1616 may be implemented at a cell site, but the corresponding the centralized unit CU-CP 1614 may be implemented at a local data center (LDC). In another example, a Distributed Unit (DU) 1604 may be implemented at a local data center (LDC) and the corresponding centralized units CU-CP 1614 and CU-UP 1616 may be implemented at an edge data center (EDC).

In some embodiments, network slicing operations may be communicated via the E1, F1-C, and F1-U interfaces of the RAN 1600. For example, CU-CP 1614 may select the appropriate DU 1604 and CU-UP 1616 entities to serve a network slicing request associated with a particular service level agreement (SLA).

FIG. 16B depicts a RAN 1640 according to at least one embodiment. As depicted, the RAN 1640 includes hardware-level components and software-level components. The hardware-level components include one or more processors 1670, one or more memory 1671, and one or more disks 1672. The one or more memory 1671 can be communicatively coupled with and readable by the one or more processors 1670 (or processing devices). The one or more memory 1671 can have stored therein processor-readable instructions when, when executed by the one or more processors 1670, cause the one or more processors 1670 to perform operations described herein. The software-level components include software applications, such as a RAN intelligent controller (RIC) 1630, virtualized CU unit (VCU) 1620, and virtualized DU unit (VDU) 1610. The software-level components may be run using the hardware-level components or executed using processor and storage components of the hardware-level components. In one example, one or more of the RIC 1630, VCU 1620, and VDU 1610 may be run using the processor 1670, memory 1671, and disk 1672. In another example, one or more of the RIC 1630, VCU 1620, and VDU 1610 may be run using a virtual processor and a virtual memory that are themselves executed or generated using the processor 1670, memory 1671, and disk 1672. In at least one embodiment, the energy saving logic 104 can be implemented in the RIC 1630 to perform the energy saving operations described herein. In at least one embodiment, the energy saving logic 104 can be implemented in the VCU 1620 to perform the energy saving operations described herein.

The software-level components also include virtualization layer processes, such as virtual machine 1673, hypervisor 1674, container engine 1675, and host operating system 1676. The hypervisor 1674 can include a native hypervisor (or bare-metal hypervisor) or a hosted hypervisor (or type 2 hypervisor). The hypervisor 1674 may provide a virtual operating platform for running one or more virtual machines, such as virtual machine 1673. A hypervisor can include software that creates and runs virtual machine instances. Virtual machine 1673 may include a set of virtual hardware devices, such as a virtual processor, a virtual memory, and a virtual disk. The virtual machine 1673 may include a guest operating system that has the capability to run one or more software applications, such as the RAN intelligent controller (RIC) 1630. The virtual machine 1673 may run the host operating system 1676 upon which the container engine 1675 may run. A virtual machine, such as virtual machine 1673, may include one or more virtual processors.

A container engine 1675 may run on top of the host operating system 1676 in order to run multiple isolated instances (or containers) on the same operating system kernel of the host operating system 1676. Containers may perform virtualization at the operating system level and may provide a virtualized environment for running applications and their dependencies. The container engine 1675 may acquire a container image and convert the container image into running processes. In some cases, the container engine 1675 may group containers that make up an application into logical units (or pods). A pod may contain one or more containers and all containers in a pod may run on the same node in a cluster. Each pod may serve as a deployment unit for the cluster. Each pod may run a single instance of an application.

In order to scale an application horizontally, multiple instances of a pod may be run in parallel. A “replica” may refer to a unit of replication employed by a computing platform to provision or deprovision resources. Some computing platforms may run containers directly and therefore a container can include the unit of replication. Other computing platforms may wrap one or more containers into a pod and therefore a pod can include the unit of replication.

A replication controller may be used to ensure that a specified number of replicas of a pod are running at the same time. If less than the specified number of pods are running (e.g., due to a node failure or pod termination), then the replication controller may automatically replace a failed pod with a new pod. In some cases, the number of replicas may be dynamically adjusted based on a prior number of node failures. For example, if it is detected that a prior number of node failures for nodes in a cluster running a particular network slice has exceeded a threshold number of node failures, then the specified number of replicas may be increased (e.g., increased by one). Running multiple pod instances and keeping the specified number of replicas constant may prevent users from losing access to their application in the event that a particular pod fails or becomes inaccessible.

In some embodiments, a virtualized infrastructure manager not depicted may run on the RAN 1640 in order to provide a centralized platform for managing a virtualized infrastructure for deploying various components of the RAN 1640. The virtualized infrastructure manager may manage the provisioning of virtual machines, containers, and pods. The virtualized infrastructure manager may also manage a replication controller responsible for managing a number of pods. In some cases, the virtualized infrastructure manager may perform various virtualized infrastructure related tasks, such as cloning virtual machines, creating new virtual machines, monitoring the state of virtual machines, and facilitating backups of virtual machines.

FIG. 16C depicts the RAN 1640 of FIG. 16B in which the virtualization layer includes a containerized environment 1679 according to at least one embodiment. The containerized environment 1679 includes a container engine 1675 for instantiating and managing application containers, such as container 1677. Containerized applications can include applications that run in isolated runtime environments (or containers). The containerized environment 1679 may include a container orchestration service for automating the deployments of containerized applications. The container 1677 may be used to deploy microservices for running network functions. The container 1677 may run DU components and/or CU components of the RAN 1640. The containerized environment 1679 may be executed using hardware-level components or executed using processor and storage components of the hardware-level components. In one example, the containerized environment 1679 may be run using the processor 1670, memory 1671, and disk 1672. In another example, the containerized environment 1679 may be run using a virtual processor and a virtual memory that are themselves executed or generated using the processor 1670, memory 1671, and disk 1672. In at least one embodiment, the energy saving logic 104 can be implemented in the RIC 1630 to perform the energy saving operations described herein. In at least one embodiment, the energy saving logic 104 can be implemented in the VCU 1620 to perform the energy saving operations described herein.

FIG. 16D depicts a RAN 1650 according to at least one embodiment. As depicted, the RAN 1650 includes hardware-level components and software-level components. The hardware-level components include a set of machines (e.g., physical machines) that may be grouped together and presented as a single computing system or a cluster. Each machine of the set of machines can include a node in a cluster (e.g., a failover cluster).

As depicted, the set of machines includes machine 1680 and machine 1690. The machine 1680 includes a network interface 1685, processor 1686, memory 1687, and disk 1688 all in communication with each other. Processor 1686 allows machine 1680 to execute computer readable instructions stored in memory 1687 to perform processes described herein. Processor 1686 may include one or more processing units, such as one or more CPUs and/or one or more GPUs. Memory 1687 can include one or more types of memory (e.g., RAM, SRAM, DRAM, ROM, EEPROM, or Flash). The disk 1688 can include a hard disk drive and/or a solid-state drive. Similarly, the machine 1690 includes a network interface 1695, processor 1696, memory 1697, and disk 1698 all in communication with each other. Processor 1696 allows machine 1690 to execute computer readable instructions stored in memory 1697 to perform processes described herein. In some embodiments, the set of machines may be used to implement a failover cluster. In some cases, the set of machines may be used to run one or more virtual machines or to execute or generate a containerized environment, such as the containerized environment 1679 depicted in FIG. 16C.

The software-level components include a RAN intelligent controller (RIC) 1630, CU control plane (CU-CP) 1614, CU user plane (CU-UP) 1616, and Distributed Unit (DU) 1604. In one embodiment, the software-level components may be run using a dedicated hardware server. In another embodiment, the software-level components may be run using a virtual machine running or containerized environment running on the set of machines. In another embodiment, the software-level components may be run from the cloud (e.g., the software-level components may be deployed using a cloud-based compute and storage infrastructure). In at least one embodiment, the energy saving logic 104 can be implemented in the RIC 1630 to perform the energy saving operations described herein. In at least one embodiment, the energy saving logic 104 can be implemented in the CU-CP 1228 to perform the energy saving operations described herein.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method comprising:
collecting, using a controller of a cellular network, input data representing conditions for potential energy saving (ES) modes in the cellular network, the input data comprising morphology data and traffic pattern data;
determining, by the controller using the input data, one or more energy saving (ES) modes for one or more components of the cellular network in at least one of a time (T) domain, a frequency (F) domain, or a space (S) domain; and
causing at least one adjustment to the one or more components in the at least one of the time (T) domain, the frequency (F) domain, or the space (S) domain according to the one or more ES modes.

2. The method of claim 1, wherein the morphology data and traffic pattern data comprises at least one of a traffic load of user equipment (UE) traffic data, a UE signal-to-noise (SNR), a UE Receive Signal Strength Indicator (RSSI), a UE Channel State Information (CSI), a number of UEs, a resource block (RB) usage rate, a type of traffic, or morphology information.

3. The method of claim 1, wherein the one or more components comprises a Radio Unit (RU) with an extreme massive Multiple Input, Multiple Output (extreme mMIMO) system that supports at least two adjacent frequency bands, wherein the extreme mMIMO system comprises a plurality of antenna ports and corresponding amplifiers and transceivers configurable to be turned on or off and weight sets being configurable to adjust a number of beams and a beam width of the number of beams, wherein the causing the at least one adjustment comprises:
configuring a first number of the plurality of antenna ports and corresponding amplifiers and transceivers to be turned on or off in a first ES mode;
configuring a first number of beams in the first ES mode; and
configuring a first beam width of the number of beams in the first ES mode.

4. The method of claim 1, wherein the one or more ES modes comprises a plurality of predefined combinations of parameters in the space (S) domain and parameters in the frequency (F) domain.

5. The method of claim 4, wherein the plurality of predefined combinations comprises:
a first combination comprising a first number of antenna ports and corresponding amplifiers and transceivers turned on for an upper frequency band and a lower frequency band, the first combination corresponding to a maximum power consumption mode;
a second combination comprising the first number of antenna ports and corresponding amplifiers and transceivers turned off for the upper frequency band and the lower frequency band, the second combination corresponding to a minimum power consumption mode of the one or more ES modes; and
one or more additional combinations comprising different number of antenna ports and corresponding amplifiers and transceivers turned on for at least one of the upper frequency band or the lower frequency band, the one or more additional combinations corresponding to others of the one or more ES modes.

6. The method of claim 5, wherein:
the first number is 256 antenna ports and corresponding amplifiers and transceivers;
the first combination comprises the 256 antenna ports and corresponding amplifiers and transceivers turned on for the upper frequency band and the lower frequency band, 32 beam weights for each of the upper frequency band and the lower frequency band, two vertical beams with a beam width of 7.5 degrees, and sixteen horizontal beams with the beam width of 7.5 degrees;
the second combination comprises the 256 antenna ports and corresponding amplifiers and transceivers turned off for the upper frequency band and the lower frequency band;
a third combination of the one or more additional combinations comprises 128 antenna ports and corresponding amplifiers and transceivers turned on for the upper frequency band and the lower frequency band, 16 beam weights for each of the upper frequency band and the lower frequency band, two vertical beams with a beam width of 15 degrees, and eight horizontal beams with the beam width of 15 degrees;
a fourth combination of the one or more additional combinations comprises 64 antenna ports and corresponding amplifiers and transceivers turned on and optimized with lower beams for the upper frequency band and the lower frequency band, 8 beam weights for each of the upper frequency band and the lower frequency band, and eight horizontal beams with the beam width of 15 degrees;
a fifth combination of the one or more additional combinations comprises 128 antenna ports and corresponding amplifiers and transceivers turned on for only the lower frequency band, 16 beam weights for the lower frequency band, two vertical beams with the beam width of 15 degrees, and eight horizontal beams with the beam width of 15 degrees;
a sixth combination of the one or more additional combinations comprises 64 antenna ports and corresponding amplifiers and transceivers turned on for only the lower frequency band, 8 beam weights for the lower frequency band, and eight horizontal beams with the beam width of 15 degrees; and
a seventh combination of the one or more additional combinations comprises 32 antenna ports and corresponding amplifiers and transceivers turned on and optimized with limited beams for only the lower frequency band, 4 beam weights for the lower frequency band, and four horizontal beams with the beam width of 30 degrees.

7. The method of claim 1, wherein the controller is at least one of a non-real-time radio access network intelligent controller (RIC), or a near-real-time RIC.

8. The method of claim 1, wherein the controller comprises a non-real-time radio access network intelligent controller (RIC) and a near-real-time RIC.

9. The method of claim 1, wherein the controller is part of an Element Management System (EMS).

10. The method of claim 9, wherein the EMS system is part of a cloud computing system or a dedicated system.

11. A non-transitory computer-readable storage medium, the computer-readable storage medium including instructions that when executed by a computing system, cause the computing system to perform operations comprising:
collecting input data representing conditions for potential energy saving (ES) modes in a cellular network, the input data comprising morphology data and traffic pattern data;
determining, using the input data, one or more energy saving (ES) modes for one or more components of the cellular network in at least one of a time (T) domain, a frequency (F) domain, or a space (S) domain; and
causing at least one adjustment to the one or more components in the at least one of the time (T) domain, the frequency (F) domain, or the space (S) domain according to the one or more ES modes.

12. The non-transitory computer-readable medium of claim 11, wherein the morphology data and traffic pattern data comprises at least one of a traffic load of user equipment (UE) traffic data, a UE signal-to-noise (SNR), a UE Receive Signal Strength Indicator (RSSI), a UE Channel State Information (CSI), a number of UEs, a resource block (RB) usage rate, a type of traffic, or morphology information.

13. The non-transitory computer-readable medium of claim 11, wherein the one or more components comprises a Radio Unit (RU) with an extreme massive Multiple Input, Multiple Output (extreme mMIMO) system that supports at least two adjacent frequency bands, wherein the extreme mMIMO system comprises a plurality of antenna ports and corresponding amplifiers and transceivers configurable to be turned on or off and weight sets being configurable to adjust a number of beams and a beam width of the number of beams, wherein the causing the at least one adjustment comprises:
configuring a first number of the plurality of antenna ports and corresponding amplifiers and transceivers to be turned on or off in a first ES mode;
configuring a first number of beams in the first ES mode; and
configuring a first beam width of the number of beams in the first ES mode.

14. The non-transitory computer-readable medium of claim 11, wherein the one or more ES modes comprises a plurality of predefined combinations of parameters in the space (S) domain and parameters in the frequency (F) domain.

15. The non-transitory computer-readable medium of claim 14, wherein the plurality of predefined combinations comprises:
a first combination comprising a first number of antenna ports and corresponding amplifiers and transceivers turned on for an upper frequency band and a lower frequency band, the first combination corresponding to a maximum power consumption mode;
a second combination comprising the first number of antenna ports and corresponding amplifiers and transceivers turned off for the upper frequency band and the lower frequency band, the second combination corresponding to a minimum power consumption mode of the one or more ES modes; and
one or more additional combinations comprising different number of antenna ports and corresponding amplifiers and transceivers turned on for at least one of the upper frequency band or the lower frequency band, the one or more additional combinations corresponding to others of the one or more ES modes.

16. The non-transitory computer-readable medium of claim 15, wherein:
the first number is 256 antenna ports and corresponding amplifiers and transceivers;
the first combination comprises the 256 antenna ports and corresponding amplifiers and transceivers turned on for the upper frequency band and the lower frequency band, 32 beam weights for each of the upper frequency band and the lower frequency band, two vertical beams with a beam width of 7.5 degrees, and sixteen horizontal beams with the beam width of 7.5 degrees;
the second combination comprises the 256 antenna ports and corresponding amplifiers and transceivers turned off for the upper frequency band and the lower frequency band;
a third combination of the one or more additional combinations comprises 128 antenna ports and corresponding amplifiers and transceivers turned on for the upper frequency band and the lower frequency band, 16 beam weights for each of the upper frequency band and the lower frequency band, two vertical beams with a beam width of 15 degrees, and eight horizontal beams with the beam width of 15 degrees;
a fourth combination of the one or more additional combinations comprises 64 antenna ports and corresponding amplifiers and transceivers turned on and optimized with lower beams for the upper frequency band and the lower frequency band, 8 beam weights for each of the upper frequency band and the lower frequency band, and eight horizontal beams with the beam width of 15 degrees;
a fifth combination of the one or more additional combinations comprises 128 antenna ports and corresponding amplifiers and transceivers turned on for only the lower frequency band, 16 beam weights for the lower frequency band, two vertical beams with the beam width of 15 degrees, and eight horizontal beams with the beam width of 15 degrees;
a sixth combination of the one or more additional combinations comprises 64 antenna ports and corresponding amplifiers and transceivers turned on for only the lower frequency band, 8 beam weights for the lower frequency band, and eight horizontal beams with the beam width of 15 degrees; and
a seventh combination of the one or more additional combinations comprises 32 antenna ports and corresponding amplifiers and transceivers turned on and optimized with limited beams for only the lower frequency band, 4 beam weights for the lower frequency band, and four horizontal beams with the beam width of 30 degrees.

17. The non-transitory computer-readable medium of claim 15, wherein the computing system comprises at least one of a non-real-time radio access network intelligent controller (RIC) or a near-real-time RIC.

18. The non-transitory computer-readable medium of claim 11, wherein the computing system comprises an Element Management System (EMS), wherein the EMS system is part of a cloud computing system or a dedicated system.

19. A computing system comprising:
a processor; and
a memory storing instructions that, when executed by the processor, configure the computing system to:
collect input data representing conditions for potential energy saving (ES) modes in a cellular network, the data comprising morphology data and traffic pattern data;
determine, using the input data, one or more energy saving (ES) modes for one or more components of the cellular network in at least one of a time (T) domain, a frequency (F) domain, or a space (S) domain; and
cause at least one adjustment to the one or more components in the at least one of the time (T) domain, the frequency (F) domain, or the space (S) domain according to the one or more ES modes.

20. The computing system of claim 19, wherein the one or more components comprises a Radio Unit (RU) with an extreme massive Multiple Input, Multiple Output (extreme mMIMO) system that supports at least two adjacent frequency bands, wherein the extreme mMIMO system comprises a plurality of antenna ports and corresponding amplifiers and transceivers configurable to be turned on or off and weight sets being configurable to adjust a number of beams and a beam width of the number of beams, wherein the causing the at least one adjustment comprises:
configuring a first number of the plurality of antenna ports and corresponding amplifiers and transceivers to be turned on or off in a first ES mode; and
configuring a first number of beams in the first ES mode; and
configuring a first beam width of the number of beams in the first ES mode.
